(19) United States
(12) Patent Application Publication
(10) Pub. No.: US 2025/0269644 A1
(43) Pub. Date: Aug. 28, 2025

(54) LIQUID DISCHARGE HEAD AND LIQUID DISCHARGE APPARATUS

(71) Applicants: Sho KAWAKAMI, Kanagawa (JP); Jun ZHANG, Kanagawa (JP); Akihiro FUJITA, Kanagawa (JP)

(72) Inventors: Sho KAWAKAMI, Kanagawa (JP); Jun ZHANG, Kanagawa (JP); Akihiro FUJITA, Kanagawa (JP)

(21) Appl. No.: 19/051,187

(22) Filed: Feb. 12, 2025

(30) Foreign Application Priority Data
Feb. 27, 2024 (JP) 2024-027406

(51) Int. Cl. B41J 2/14; B41J 2/16; B41J 2/165

(52) U.S. Cl. CPC B41J 2/1433; B41J 2/162; B41J 2/1623; B41J 2/165; B41J 2002/14411

(57) ABSTRACT

A liquid discharge head includes: a nozzle from which a liquid is dischargeable in a first direction; and a first positioning hole in the first direction; a channel member on the nozzle plate having: a channel communicating with the nozzle; a second positioning hole in the first direction; and a communication hole on an outer peripheral surface of the channel member, the communication hole in a second direction orthogonal to the first direction; a positioning member inserted through the first positioning hole and the second positioning hole in the first direction to position the nozzle plate relative to the channel member; and a fixing member inserted through the communication hole in the second direction.

### CROSS-REFERENCE TO RELATED APPLICATIONS

This patent application is based on and claims priority pursuant to 35 U.S.C. § 119 (a) to Japanese Patent Application No. 2024-027406, filed on Feb. 27, 2024, in the Japan Patent Office, the entire disclosure of which is hereby incorporated by reference herein.

### BACKGROUND

### Technical Field

The present embodiment relates to a liquid discharge head and a liquid discharge apparatus.

### Related Art

The liquid head includes a nozzle plate having a nozzle, a channel member having a channel through which liquid to be discharged from the nozzle flows, and a positioning member inserted into a positioning hole of the nozzle plate and a positioning hole of the channel member and positions the nozzle plate on the channel member. The nozzle plate is joined to the channel member.

### SUMMARY

In an aspect of the present disclosure, a liquid discharge head is provided that includes: a nozzle plate having: a nozzle from which a liquid is dischargeable in a first direction; and a first positioning hole in the first direction; a channel member on the nozzle plate having: a channel communicating with the nozzle; a second positioning hole in the first direction; and a communication hole on an outer peripheral surface of the channel member, the communication hole in a second direction orthogonal to the first direction; a positioning member inserted through the first positioning hole and the second positioning hole in the first direction to position the nozzle plate relative to the channel member; and a fixing member inserted through the communication hole in the second direction, the fixing member pressing, in the second direction, an outer peripheral surface of the positioning member into contact with an inner peripheral surface of at least one of the first positioning hole or the second positioning hole. The positioning member has a predetermined gap between the positioning member and each of the first positioning hole and the second positioning hole.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a front view of a liquid discharge head according to the present embodiment;

FIG. 2 is a perspective view of the liquid discharge head as viewed obliquely from below;

FIG. 3 is a front view of the liquid discharge head from which a lower housing is removed;

FIG. 4 is an enlarged perspective view of a lower end of the liquid discharge head from which a lower housing is removed;

FIG. 5 is a cross-sectional view perpendicular to an X direction of the liquid discharge head;

FIG. 6A is a cross-sectional view perpendicular to a Y direction of the liquid discharge head;

FIG. 6B is a view illustrating a flow of liquid in a channel;

FIGS. 7A to 7E are views describing a positioning structure of a nozzle plate and a lower housing according to Example 1;

FIG. 8 is a process flow diagram of diffusion bonding;

FIG. 9 is a schematic view of a diffusion bonding device;

FIG. 10 is a schematic view illustrating a configuration of Comparative Example 1;

FIG. 11 is a bottom view of a nozzle plate in Example 2;

FIGS. 12A and 12B are schematic views illustrating a configuration of Example 3;

FIGS. 13A to 13C are schematic views illustrating a configuration of Example 4;

FIG. 14 is a schematic view illustrating a configuration of Comparative Example 2;

FIGS. 15A and 15B are schematic views illustrating a configuration of Comparative Example 3;

FIG. 16 is a schematic configuration diagram of an inkjet printer as a liquid discharge apparatus;

FIG. 17 is a perspective view illustrating an arrangement example of the inkjet printer with respect to an automobile; and

FIG. 18 is a diagram illustrating an example of an electrode manufacturing apparatus as a liquid discharge apparatus including a liquid discharge head according to the present embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A best mode for carrying out the present embodiment will be hereinafter described with reference to the drawings. It is to be understood that those skilled in the art can easily change and correct the present embodiment within the scope of claims to form other embodiments, and these changes and corrections are included in the scope of claims. The following description is an example of the best mode of the present embodiment, and does not limit the scope of claims.

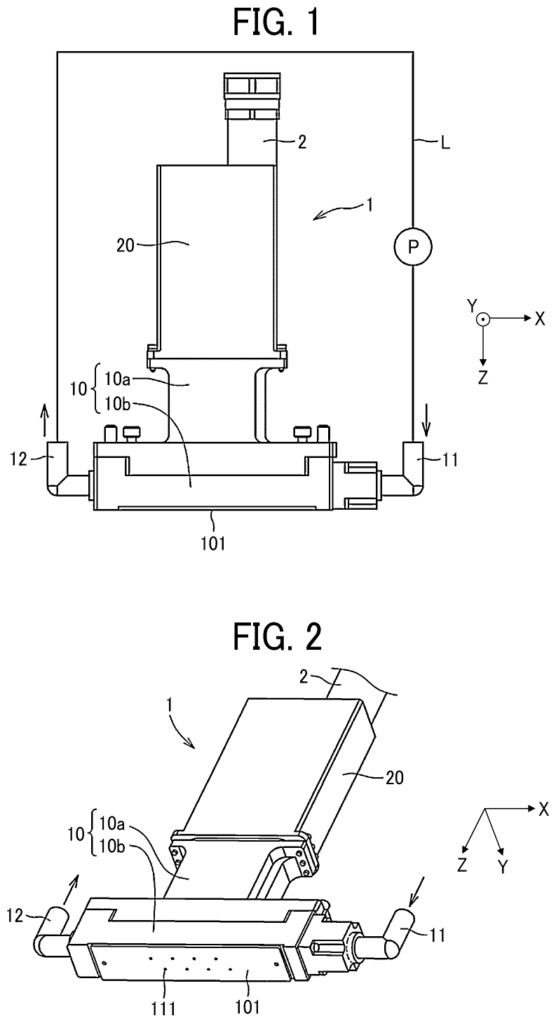

FIG. 1 is a front view of a liquid discharge head 1, and FIG. 2 is a perspective view of the liquid discharge head 1 as viewed obliquely from below. In FIGS. 1 and 2, a longitudinal direction of the liquid discharge head 1 (nozzle arrangement direction) is defined as an X direction, and a lateral direction of the liquid discharge head 1 is defined as a Y direction. A height direction of the liquid discharge head 1 (a liquid discharge direction from a nozzle 111) is defined as a Z direction. In the subsequent drawings, the definition of coordinates is similar unless otherwise specified.

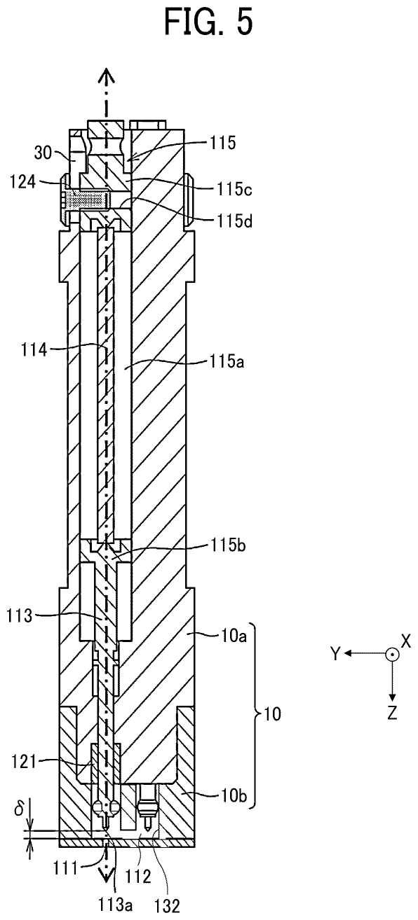

The liquid discharge head 1 includes a housing 10 and a nozzle plate 101 in which a plurality of nozzles 111 is arranged. The housing 10 includes an upper housing 10a and a lower housing 10b as a channel member having a channel 112 (see FIG. 5). The upper housing 10a and the lower housing 10b can be integrally formed. The upper housing 10a and the lower housing 10b are integrated by diffusion bonding.

Overall dimensions of the housing 10 can be, for example, 80 mm in length (X-axis direction)×25 mm in width (Y-axis direction)×15 mm in thickness (Z-axis direction). As a material of the housing 10, for example, stainless steel (SUS430) can be used.

A cover 20 is attached on the upper housing 10a. Electric components are disposed inside the cover 20. A connector 2 of an electric component is provided at an upper end of the cover 20.

The nozzle plate 101 made of metal such as corrosion-resistant stainless steel (SUS430) is disposed on a lower surface of the lower housing 10b. The nozzle plate 101 is provided with nozzles 111 for discharging liquid. The lower housing 10b and the nozzle plate 101 are also integrated by diffusion bonding. The surface roughness of the lower surface of the lower housing 10b to which the nozzle plate 101 is joined is Ra 0.01 μm or less.

The nozzles 111 of the nozzle plate 101 are arranged in two rows in a staggered manner. By arranging the nozzles in multiple rows in a staggered manner, it is possible to achieve high image quality, downsizing of the apparatus, and improvement of a production rate by expansion of a coating area without inclining the nozzle plate 101 with respect to the printing direction.

At one end of the lower housing 10b in the X direction, a supply port 11 that communicates with the channel 112 (see FIG. 5) provided in the lower housing 10b and supplies liquid is provided. At one end of the lower housing 10b in the X direction, a collection port 12 that communicates with the channel 112 (see FIG. 5) and from which liquid in the channel is discharged is provided.

As illustrated in FIG. 1, the supply port 11 and the collection port 12 are coupled via the circulation path L, and pressurized liquid pressurized by a pump P of a circulation path L is supplied to the supply port 11. The pressurized liquid that has not been discharged from the nozzle 111 is collected from the collection port 12 and then supplied to the supply port 11 again via the circulation path L and the pump P.

In the liquid discharge head 1 of the present embodiment, in order to increase a liquid feeding pressure of the supply port 11 by a magnitude of several 100 kPa, a peripheral edge portion of the nozzle plate 101 and the housing 10 are firmly joined by direct joining such as diffusion bonding.

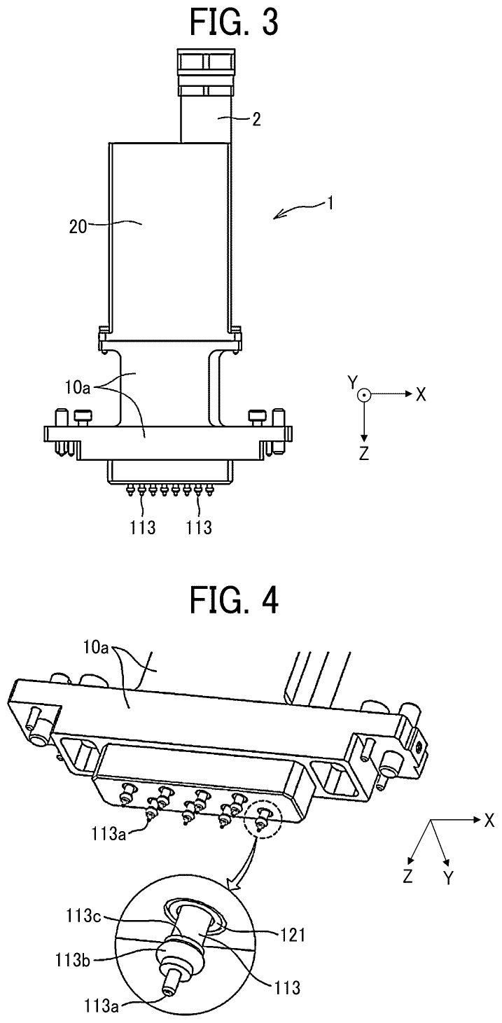

FIG. 3 is a front view of the liquid discharge head 1 from which the lower housing 10b is removed, and FIG. 4 is an enlarged perspective view of a lower end of the liquid discharge head from which the lower housing 10b is removed.

As illustrated in FIGS. 3 and 4, when the lower housing 10b is removed, a tip portion of a needle valve 113, which is a shaft-like member and a valve member, is exposed. The needle valve 113 is movably received in the Z direction by a bearing 121 provided on a lower surface of the upper housing 10a. The needle valve 113 is made of metal such as corrosion-resistant SUS, and has a very thin shape with a diameter of 1 mm or less at a thin portion and a diameter of about 2 mm at a thick portion. The thin needle valve 113 is exposed from the bearing 121 of the upper housing 10a by a length of, for example, 1 to 20 mm.

A valve body 113a as a tip member is attached to a tip portion of the needle valve 113. On an upper side of the valve body 113a, an O-ring 113b having elasticity as a sealing member and a washer 113c for securing the O-ring 113b to the needle valve 113 are disposed.

An outer peripheral surface of the O-ring 113b is in contact with an inner peripheral surface of a valve through hole 132 provided in the lower housing 10b to seal between the channel 112 and the space for accommodating a piezoelectric element 114 of the upper housing 10a.

FIG. 5 is a cross-sectional view of the liquid discharge head 1 perpendicular to the X direction.

As illustrated in FIG. 5, the needle valve 113 and the piezoelectric element 114, which is an actuator that drives the needle valve 113 and is a driving unit, are disposed in the upper housing 10a along the Z direction. The piezoelectric element 114 is held in a central space 115a of a holding member 115.

The holding member 115 is disposed in the upper housing 10a so as to be positionally adjustable in the vertical direction (Z direction) in FIG. 5. A rear end portion 115c of the holding member 115 is positioned and secured to the upper housing 10a by a fixing screw 124. The rear end portion 115c of the holding member 115 includes a female screw hole 115d in a direction orthogonal to the Z direction, and a tip of the fixing screw 124 is screwed into the female screw hole 115d.

An elongated long hole 30 in the Z direction is provided in an upper end of the upper housing 10a, and a fixing screw 124 is inserted into the long hole 30. When the fixing screw 124 is loosened, the holding member 115 can move up and down.

In the state of FIG. 5, the fixing screw 124 is fastened and secured to the long hole 30 at a position where there is a predetermined gap 8 between the valve body 113a and the nozzle 111. In this state, the liquid discharge head 1 is delivered as a product. On the other hand, when the liquid discharge head is used, the position of the holding member 115 is adjusted and tightened so that the valve body 113a comes into contact with the nozzle plate 101 at a predetermined pressure.

Spring portions are provided at both upper and lower end portions of the holding member 115, and the piezoelectric element 114 is held in a compressed state in the Z direction by the spring portions. A rear end portion of the needle valve 113 is coupled to a tip portion 115b of the holding member 115 so that the piezoelectric element 114 and the needle valve 113 are concentric.

When no voltage is applied to the piezoelectric element 114, the needle valve 113 closes the nozzle 111. Thus, even if the pressurized liquid is supplied to the channel 112, the liquid is not discharged from the nozzle 111.

The piezoelectric element 114 is operated in a d31 mode in which the piezoelectric element contracts when a voltage is applied by a voltage application unit. When the piezoelectric element 114 contracts in the Z direction, the holding member 115 contracts in the Z direction by the biasing force of the spring portion. Thus, the needle valve 113 coupled to the tip portion 115b of the holding member 115 moves in a direction (−Z direction) of separating from the nozzle 111, and the nozzle 111 is opened.

When no voltage is applied to the piezoelectric element 114, the needle valve 113 may open the nozzle 111. In this case, the piezoelectric element 114 is operated in a d33 mode of extending when a voltage is applied, and the needle valve 113 is moved toward the nozzle 111 to close the nozzle 111. The d33 mode of the piezoelectric element 114 has high responsiveness and a large displacement amount. Therefore, the d33 mode is suitable when it is desired to enhance the responsiveness of the opening/closing operation of the needle valve 113 and reduce the variation in the droplet speed and the droplet amount of the liquid discharged from the nozzle 111.

Although the needle valve 113 is driven using the piezoelectric element 114 in the above description, the needle valve may be driven using a solenoid. The needle valve 113 may be driven by air pressure or hydraulic pressure.

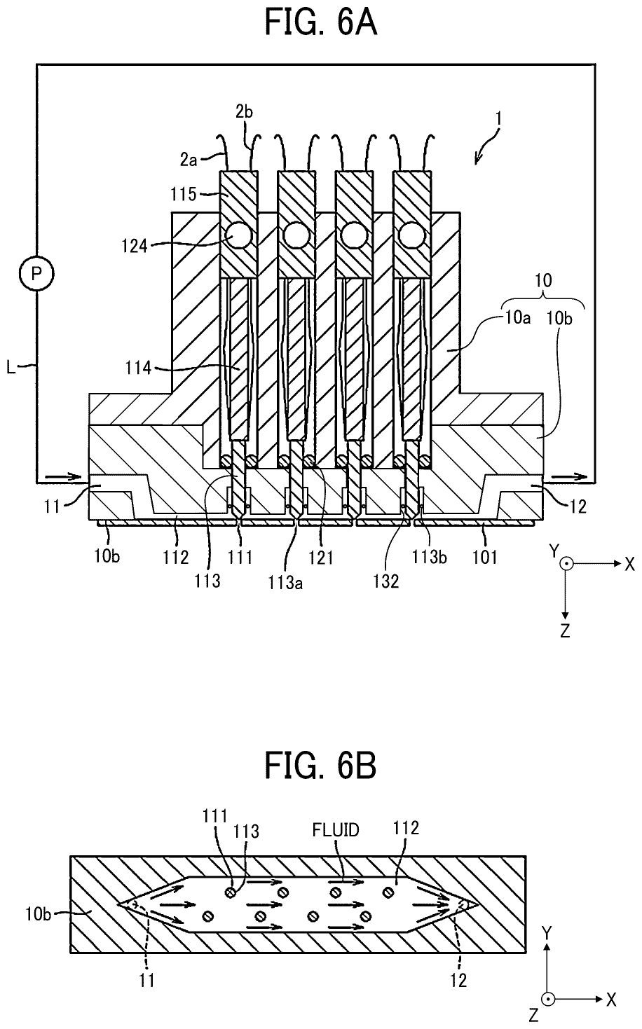

FIG. 6A is a cross-sectional view perpendicular to the Y direction of the liquid discharge head 1, and FIG. 6B is a view illustrating a flow of liquid in the channel 112.

In the present embodiment, as described above, the nozzle plate 101 includes the eight nozzles 111 arranged in a staggered manner, and includes two nozzle rows. The nozzle 111 is formed by pressing, etching, or the like. A needle valve 113 is provided corresponding to each of the nozzles 111, and the nozzle 111 is opened and closed by a valve body 113a at a tip of the needle valve. Note that 2a and 2b in FIG. 6A are lead wires of the connector 2.

As illustrated in FIG. 6B, the lower housing 10b includes the channel 112 through which liquid flows, and the supply port 11 is coupled to one end in the X direction and the collection port 12 is coupled to the other end in the X direction. As indicated by an arrow in FIG. 6B, the liquid in the channel 112 flows from the supply port 11 toward the collection port 12.

The materials of the nozzle plate 101 and the housing 10 are not particularly limited, and can be appropriately selected according to the purpose, but a material having corrosion resistance to a high-pressure liquid and sufficient strength is preferable. As the material of the nozzle plate 101 and the housing 10, for example, stainless steel, Al, Bi, Cr, InSn, ITO, Nb, Nb₂O₅, NiCr, Si, SiO₂, Sn, Ta₂O₅, Ti, W, ZAO (ZnO+Al₂O₃), Zn, or the like can be selected.

Among the materials, one type may be used alone, or two or more types may be used in combination. Among them, stainless steel is preferable from the viewpoint of rust prevention property.

Due to a positional shift of the nozzle plate 101 with respect to the housing 10, an axial center of the needle valve 113 held in the housing 10 via the bearing 121 and the center of the nozzle 111 are shifted. Hereinafter, a positional shift between the axial center of the needle valve 113 and the center of the nozzle 111 is referred to as a concentricity shift. The concentricity shift between the needle valve 113 and the nozzle 111 deteriorates the sealability of the nozzle 111 and affects the discharging performance such as discharge bending.

Accordingly, in the present embodiment, in order to prevent the concentricity shift between the needle valve 113 and the nozzle 111, the nozzle plate 101 is accurately positioned in the lower housing 10b, and the nozzle plate 101 is diffusion-bonded to the housing 10. Hereinafter, a positioning structure between the nozzle plate 101 and the lower housing will be described as Examples 1 to 4.

### Example 1

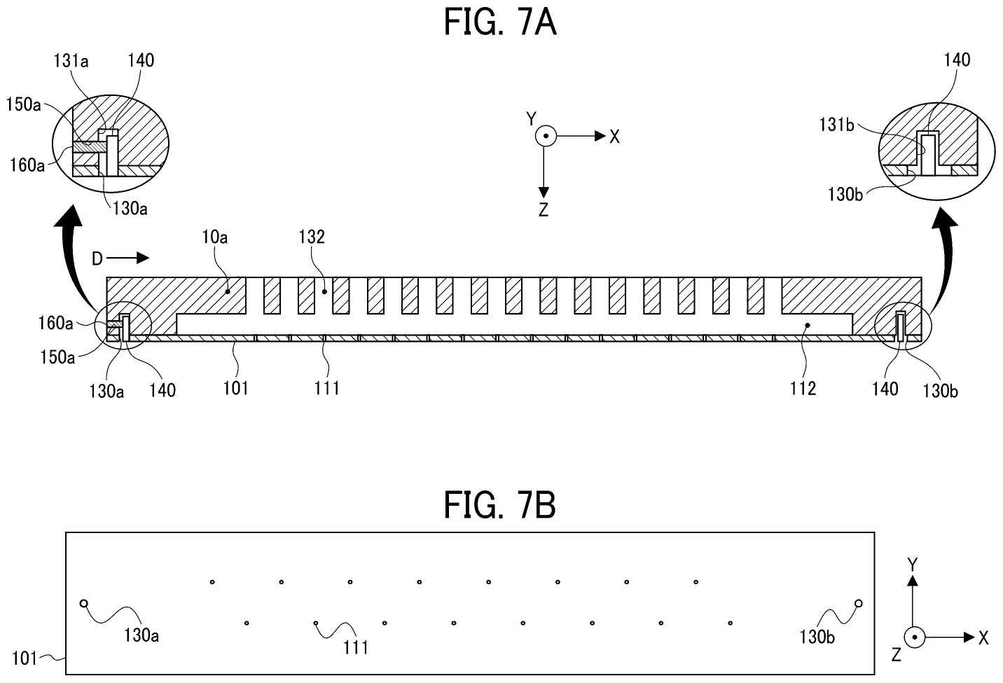

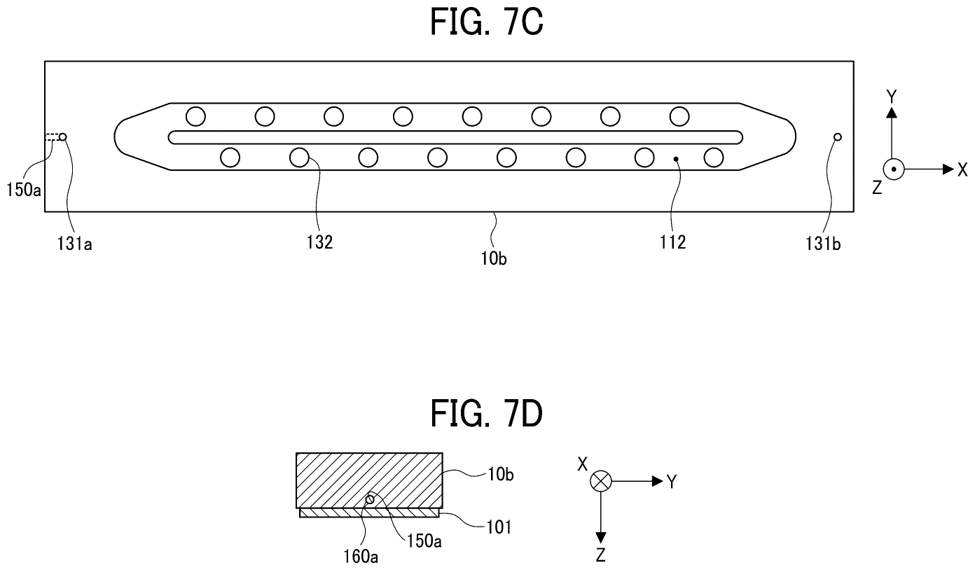

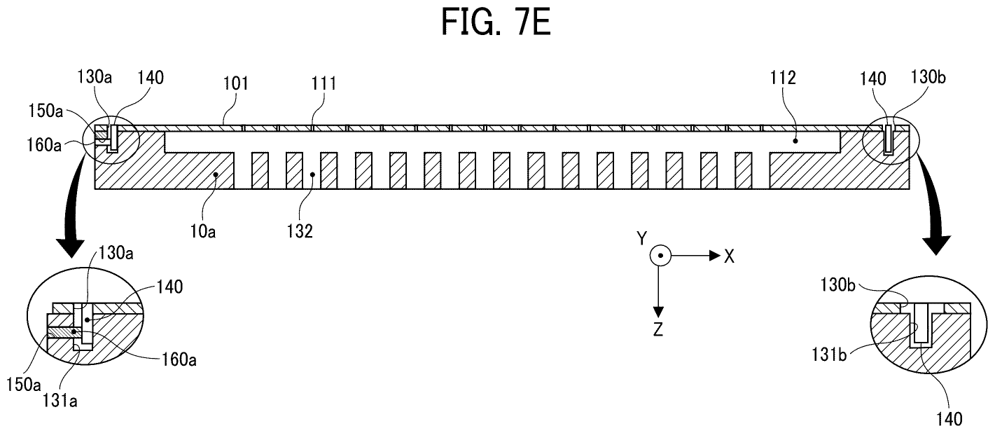

FIGS. 7A to 7E are views describing a positioning structure of the nozzle plate 101 and the lower housing 10b in Example 1, and FIG. 7A is a cross-sectional view perpendicular to the Y direction of a stacked plate including the lower housing 10b and the nozzle plate 101 positioned in the lower housing 10b. FIG. 7B is a bottom view of the nozzle plate 101, and FIG. 7C is a bottom view of the lower housing 10b. FIG. 7D is a view as viewed from a direction of an arrow D in FIG. 7A, and FIG. 7E is a schematic view illustrating a posture when the nozzle plate 101 is diffusion-bonded to the lower housing 10b.

The nozzle plate 101 in Example 1 has a rectangular planar plate shape, and both ends of the nozzle plate 101 in the arrangement direction (X direction) of the nozzles 111 are positioned in the lower housing 10b. The main reference positioning hole 130a and the sub-reference positioning hole 130b are round holes and are provided at both ends in the X direction of the nozzle plate 101.

The main reference positioning hole 130a at the left end in the drawings is a main reference for positioning and is a round hole having a diameter of 1.01 mm. On the other hand, the sub-reference positioning hole 130b at the right end in the drawings is a sub-reference for positioning, is a round hole having a diameter of 1.05 mm, and has a diameter larger than that of the main reference positioning hole 130a.

Here, both ends of the nozzle plate 101 in the arrangement direction (X direction) of the nozzles 111 are regions near both ends of the nozzle plate 101 in the X direction. For example, the both ends may be near a nozzle located at the end of the array of the nozzles 111, or may be a region on the outer side in the X direction of the array of the nozzles 111.

The material of the nozzle plate 101 of Example 1 is a stainless steel material (SUS430), the overall dimensions of the nozzle plate 101 are length 119 mm×width 21 mm×thickness 0.5 mm, and the surface roughness is Ra 0.01 μm or less. On the nozzle plate 101 illustrated in FIG. 7B, eight nozzles 111 having a diameter of 0.3 mm are arranged in two rows at equal intervals in a staggered manner. The nozzle 111 is formed by pressing, etching, or the like.

Positioning holes 131a and 131b are also provided at both ends in the X direction of the lower housing 10b of Example 1. The positioning holes 131a and 131b are arranged at the same positions as the main reference positioning hole 130a and the sub-reference positioning hole 130b of the nozzle plate 101. The positioning holes 131a and 131b of the housing are round holes having a diameter of 1.01 mm, and have an effective depth of 2.3 mm.

At one end (left end in the drawing) of the lower housing in the X direction, a female screw portion 150a which is a communication hole extending in the X direction from a side surface of the lower housing 10b orthogonal to the X direction and communicating with the main reference positioning hole 130a is provided. In Example 1, a center position of the female screw portion 150a is located at the center in the lateral direction (Y direction) of the lower housing 10b, and the female screw portion 150a is provided at a position of 1.5 mm in the −Z-axis direction from the bottom surface of the lower housing. The female screw portion 150a may be provided obliquely, not at a right angle, from the side surface of the lower housing 10b. In Example 1, the female screw portion 150a is, for example, M1.6 and has a pitch of 0.35 mm. The female screw portion 150a is obtained by forming a communication hole by drilling and then forming a screw groove on the inner peripheral surface by tapping. The nominal diameter and position of the female screw portion 150a are not limited to the above, and may be appropriately set according to a fixing member screwed into the female screw portion 150a. The communication hole is referred to also as a “fixing hole”.

The lower housing 10b is provided with a plurality of valve through holes 132 through which the needle valve 113 passes. The diameter of the valve through hole 132 is 2.85 mm, and the valve through hole is formed by drilling.

The material of the lower housing 10b of Example 1 is the same type of stainless steel material (SUS430) as the nozzle plate 101. The overall dimensions of the lower housing 10b are length 120 mm×width 22 mm×thickness 8.5 mm. The surface roughness of the joint surface with the nozzle plate 101 is Ra 0.01 μm or less.

By using the same type of stainless steel material (SUS430) for the lower housing 10b and the nozzle plate 101, it is possible to prevent the occurrence of distortion due to a difference in thermal expansion coefficient at the time of heating during diffusion bonding described later.

A positioning pin 140 as a positioning member is inserted into each of a hole including the main reference positioning hole 130a of the nozzle and the positioning hole 131a of the housing and a hole including the sub-reference positioning hole 130b of the nozzle and the positioning hole 131b of the housing. In Example 1, the material of the positioning pin 140 is the same type of stainless steel material (SUS430) as the lower housing 10b and the nozzle plate 101. Note that the material of the positioning pin 140 is not limited to the above, and may be, for example, stainless steel other than SUS430.

An overall dimension of the positioning pin 140 is 2.7 mm in length. The depth of the hole is 2.8 mm (thickness of nozzle plate 101: 0.5 mm+effective depth of positioning holes 131a and 131b of housing: 2.3 mm) from the main reference positioning hole 130a and the sub-reference positioning hole 130b of the nozzle plate and the positioning holes 131a and 131b of the housing. Accordingly, the positioning pin 140 is at a position retracted 0.1 mm from the bottom surface of the nozzle plate 101 so as not to interfere with the pressure plate at the time of diffusion bonding described later.

In Example 1, the diameter of the positioning pin 140 is set to 0.995 mm, which is shorter than the positioning holes 131a and 131b of the housing (diameter: 1.01 mm), and the main reference positioning hole 130a and the sub-reference positioning hole 130b of the nozzle plate (diameter: 1.01 mm and diameter: 1.05 mm). Thus, the positioning pin 140 is fitted in the positioning holes 131a and 131b of the housing with a gap, and has a predetermined gap with the positioning hole of the housing.

A fixing member 160a with a male screw is screwed into the female screw portion 150a, and the positioning pin 140 that penetrates the female screw portion 150a and is inserted into the positioning hole 131a of the housing is pushed toward the nozzle side (inner side) in the X direction. By being pushed by the fixing member 160a, the positioning pin 140 is pressed against an inner peripheral surface of the positioning hole 131a on the nozzle side, and is secured in the positioning hole 131a.

In Example 1, the fixing member 160a is a hexagon socket set screw made of stainless steel (SUS430) of M1.6 with a pitch of 0.35 mm and a length of 3 mm. Examples of a tip shape of the fixing member 160a abutting on the positioning pin 140 include a recessed tip, a flat tip, a pointed tip, a bar tip, and a hemispherical ball screw. The material and size of the fixing member 160a are not limited to the above, and for example, the material may be stainless steel other than SUS430, and it is sufficient if a size corresponding to the nominal diameter of the female screw portion 150a is selected as the hexagon socket set screw.

Next, diffusion bonding of the nozzle plate 101 and the lower housing 10b will be described.

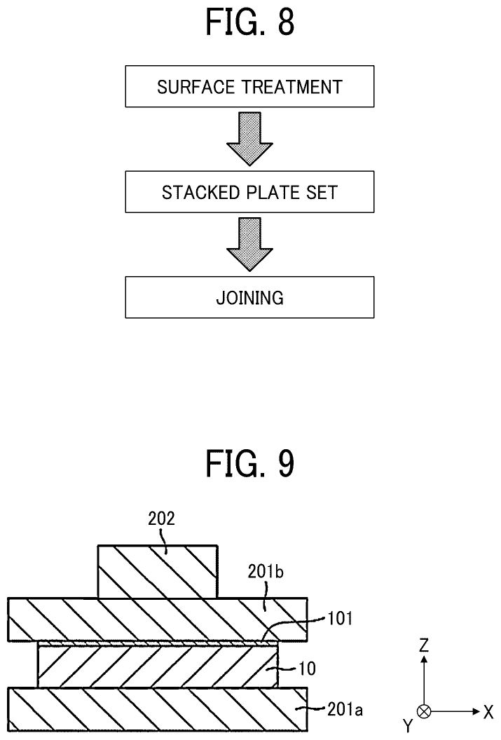

FIG. 8 is a process flow diagram of diffusion bonding, and FIG. 9 is a schematic view of a diffusion bonding device 200.

In the diffusion bonding, bonding is performed by atom transfer between materials of the nozzle plate 101 and the lower housing 10b under heating and pressurizing conditions without using an adhesive. When the nozzle plate 101 is joined to the lower housing 10b with an adhesive, the nozzle plate 101 may be attached to the lower housing 10b in an inclined manner due to a thickness variation of the adhesive. As a result, there is a risk of affecting the nozzle sealing performance of the needle valve 113 and the discharging performance of the liquid from the nozzle 111. On the other hand, in the diffusion bonding, the nozzle plate 101 can be bonded to the lower housing 10b without using an adhesive, and it is possible to prevent the nozzle plate 101 from being attached to the lower housing 10b in an inclined manner.

As illustrated in FIG. 8, the diffusion bonding mainly includes three processes of a surface treatment process, a stacked plate setting process of setting a stacked plate including the lower housing 10b and the nozzle plate 101, and a bonding process.

The surface treatment process is a process of degreasing the surfaces of the nozzle plate 101, the lower housing 10b, the positioning pin 140, and the fixing member 160a with acetone.

The stacked plate setting process includes an assembling process of assembling the nozzle plate 101 to the lower housing 10b and a process of setting the stacked plate including the assembled lower housing 10b and the nozzle plate 101 in the diffusion bonding device 200.

In the assembling process, first, the bottom surface (surface to which the nozzle plate 101 is joined) of the lower housing 10b is installed upward, and the positioning pin 140 is inserted into each of the positioning holes 131a and 131b of the lower housing 10b. As described above, in Example 1, the diameter of the positioning pin 140 is shorter than the diameter (inner diameter) of the positioning holes 131a and 131b of the housing. Therefore, the positioning pin 140 can be easily inserted into the positioning holes 131a and 131b of the housing.

Next, the nozzle plate 101 is positioned in the lower housing 10b by inserting the positioning pins 140 inserted into the main reference positioning hole 130a and the sub-reference positioning hole 130b of the housing into the positioning holes 131a and 131b of the nozzle plate 101. As described above, since the diameter of the positioning pin 140 is shorter than the diameters (inner diameters) of the main reference positioning hole 130a and the sub-reference positioning holes 130b of the nozzle plate, the positioning pin 140 can be easily inserted into the main reference positioning hole 130a and sub-reference positioning hole 130b of the nozzle plate 101.

Next, the fixing member 160a is screwed into the female screw portion 150a, and the positioning pin 140 inserted into the main reference positioning hole 130a is pushed by the fixing member 160a. Thus, the positioning pin 140 abuts at least an inner peripheral surface of the positioning hole 131b of the housing, and the positioning pin 140 is clamped and secured between the fixing member 160a and the positioning hole of the housing in a posture parallel to the Z direction which is the insertion direction of the positioning pin.

In Example 1, the diameter of the positioning hole 131a of the housing is 1.001 mm, and the diameter of the positioning pin 140 is 0.995 mm. Thus, the center of the positioning pin 140 secured to the fixing member 160a is shifted by 7.5 μm to the center side in the X direction of the housing with respect to the center of the positioning hole 131a of the housing. Accordingly, by butting the center side (+X direction side) of the main reference positioning hole 130a of the nozzle plate against the positioning pin 140 to perform positioning, the center of the positioning hole 131a of the housing and the center of the positioning hole of the nozzle plate can be matched, and the nozzle plate can be attached to the housing without positional shift.

Even if the nozzle plate is displaced in the +X direction with respect to the housing, the positional shift amount is 15 μm, and the nozzle plate 101 is positioned with respect to the lower housing 10b by 0 to 15 μm in the X direction.

On the other hand, the position of the center of the positioning hole 131b of the housing in the Y direction substantially coincides with the position of the center of the positioning pin 140 secured to the fixing member 160a. Thus, when there is no positional shift of the nozzle plate 101 with respect to the lower housing 10b, the gap in the Y direction between the positioning pin 140 secured to the fixing member 160a and the main reference positioning hole 130a of the nozzle plate 101 is 7.5 μm. Therefore, the nozzle plate 101 is positioned at 0 to 7.5 μm in the Y direction with respect to the lower housing 10b.

When the nozzle plate 101 is positioned in the lower housing 10b and the assembling process is completed, the stacked plate including the lower housing 10b and the nozzle plate 101 is set at a predetermined position of the lower pressure plate 201a of the diffusion bonding device 200. As the diffusion bonding device 200, a vacuum hot press machine (FVHP-R-750 FRET-300) can be used.

As illustrated in FIG. 9, the diffusion bonding device 200 includes a lower pressure plate 201a on which the stacked plate is set and an upper pressure plate 201b secured to an upper ram 202, and the upper ram 202 is configured to be vertically slidable. The upper pressure plate 201b and the lower pressure plate 201a are made of a ceramic member.

After the stacked plate including the lower housing 10b and the nozzle plate 101 is set on the lower pressure plate 201a, the upper ram 202 is lowered. Then, as illustrated in FIG. 9, the stacked plate including the lower housing 10b and the nozzle plate 101 is sandwiched between the upper pressure plate 201b and the lower pressure plate 201a and pressurized.

In Example 1, as described above, the overall dimension of the positioning pin 140 is 2.7 mm in length. On the other hand, the depth of the hole including the main reference positioning hole 130a and the sub-reference positioning hole 130b of the nozzle plate and the positioning holes 131a and 131b of the housing is 2.8 mm (thickness of nozzle plate 101: 0.5 mm+effective depth of positioning holes 131a and 131b of housing: 2.3 mm). In this manner, the positioning pin 140 is retracted by 0.1 mm with respect to a nozzle surface of the nozzle plate 101. Therefore, the positioning pin 140 does not interfere with the upper pressure plate 201b, and the entire surface of the nozzle plate 101 can be pressurized by the upper pressure plate 201b. It is sufficient if the length of the positioning pin 140 does not protrude outward from the main reference positioning hole 130a and the sub-reference positioning hole 130b, and can be extended up to 2.8 mm. In this case, the tip portion of the positioning pin 140 is at the same height as the outer edge portions of the main reference positioning hole 130a and the sub-reference positioning hole 130b, but does not interfere with the upper pressure plate 201b in the diffusion bonding.

In the bonding process by the diffusion bonding device 200, a load of 53 kN or more is applied by the pair of pressure plates 201a and 201b, and a pressure of 20 MPa or more is applied to the stacked plate including the lower housing 10b and the nozzle plate 101. In a state where a pressure of 20 MPa or more is applied to the stacked plate, the degree of vacuum is raised to 1.0×10⁻⁴ Pa and 800° C. to 1000° C., and then the temperature is maintained for 10 minutes to 1 hour. Accordingly, the nozzle plate 101 is diffusion-bonded to the lower housing 10b. After the diffusion bonding, furnace cooling or cooling with Ar gas is performed.

The positioning pin 140 may be removed after the nozzle plate 101 is joined to the lower housing 10b, or may be left as it is. In the case of leaving, since the positioning pin 140 inserted into the sub-reference positioning hole 130b of the nozzle plate 101 is not secured, the positioning pin is secured by pouring an adhesive into the positioning hole 131b of the housing.

The nozzle plate 101 and the lower housing 10b are made of the same type of stainless steel material (SUS430), and the nozzle plate 101 and the lower housing 10b have the same linear expansion coefficient. However, since the heat capacity is different between the nozzle plate 101 and the lower housing 10b, the temperature rise speed of the nozzle plate 101 and the temperature rise speed of the lower housing 10b are different from each other. Thus, at the time of temperature rise of the diffusion bonding, the thermal expansion speed of the thin nozzle plate 101 is faster than the thermal expansion speed of the lower housing 10b. As a result, the positioning pin 140 is pushed into the positioning hole of the nozzle plate 101 by thermal expansion at the time of temperature rise from 800° C. to 1000° C. in the diffusion bonding.

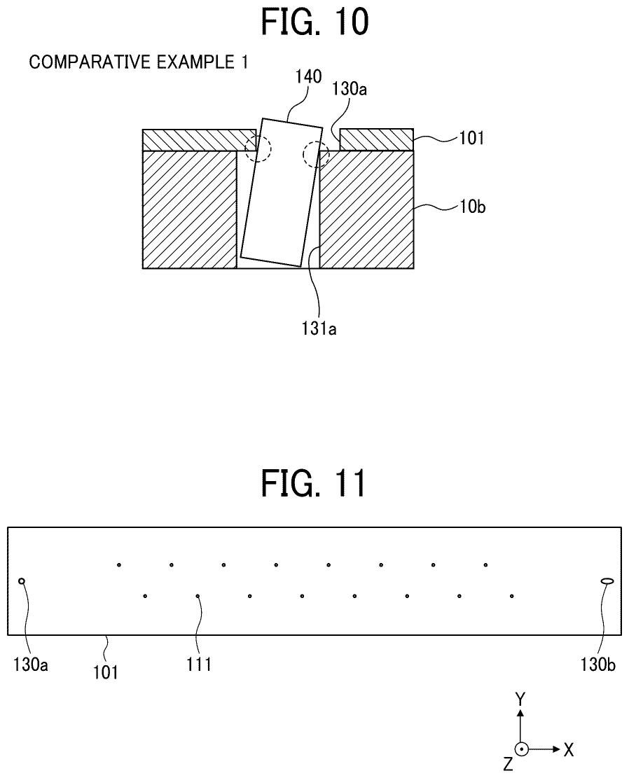

FIG. 10 is a schematic view illustrating a configuration of Comparative Example 1. In a case where the positioning pin 140 is not secured to the positioning hole 131a of the housing and is configured to be freely movable within a predetermined range, as illustrated in FIG. 10, when the positioning pin 140 is pushed by thermal expansion of the nozzle plate 101, the positioning pin 140 is inclined in the positioning hole 131a. Such inclination deteriorates positional accuracy of the nozzle plate 101 with respect to the lower housing 10b. In particular, the main reference positioning hole 130a having a short diameter and a narrow gap from the positioning pin comes into contact with the positioning pin at the time of temperature rise of the diffusion bonding, and the positioning pin 140 may tilt.

For example, as in the example, in the case of the diameter 0.995 mm of the positioning pin 140 and the diameter 1.001 of each of the main reference positioning hole 130a and the positioning hole 131a, the nozzle plate 101 is positionally shifted with respect to the lower housing 10b by 15 μm or more due to the inclination of the positioning pin 140. There is a risk that the nozzle plate 101 is diffusion-bonded to the lower housing 10b in a positionally shifted state.

As a result, the concentricity shift between the needle valve 113 and the nozzle 111 deviates from a prescribed range, and desired sealing performance or discharging performance may not be obtained.

As illustrated in FIG. 10, when the positioning pin 140 is inclined, the positioning pin 140 comes into contact with the edge of the main reference positioning hole 130a of the nozzle plate 101 and the edge of the positioning hole 131a of the housing in point contact. At the time of the diffusion bonding, since the positioning pin 140 is exposed to a high temperature, the positioning pin is easily deformed. Thus, when the positioning pin 140 is further pushed by thermal expansion of the nozzle plate 101 from the state illustrated in FIG. 10, stress concentrates on the portion of the point contact, and the positioning pin 140 may be deformed. As a result, the positional shift of the nozzle plate 101 with respect to the lower housing 10b may be further deteriorated.

On the other hand, in Example 1, an outer peripheral surface of the positioning pin 140 inserted into the main reference positioning hole 130a of the nozzle plate is clamped between the inner peripheral surface of the positioning hole 131a of the housing and the fixing member 160a, and is secured in a posture parallel to the Z direction. Accordingly, even when the positioning pin 140 is pushed by thermal expansion of the nozzle plate 101 at the time of temperature rise of the diffusion bonding, the positioning pin 140 is not inclined, and the posture parallel to the Z direction can be maintained.

By fixing the positioning pin 140, a load applied to the positioning pin 140 due to thermal expansion of the nozzle plate 101 increases. However, since the positioning pin 140 is not inclined, the positioning pin 140 is in line contact with the inner peripheral surface of the main reference positioning hole 130a of the nozzle plate, or in contact with the inner peripheral surface by a certain area. Thus, a local stress concentration portion does not occur in the positioning pin 140. Therefore, even if the load applied to the positioning pin 140 due to the thermal expansion of the nozzle plate 101 increases, the deformation of the positioning pin 140 can be favorably prevented. Thus, it is possible to prevent deterioration of positional shift of the nozzle plate 101 with respect to the lower housing 10b at the time of the diffusion bonding. Therefore, the concentricity shift between the needle valve 113 and the nozzle 111 can be prevented from deviating from the prescribed range.

In addition, by press-fitting the positioning pin 140 into the positioning hole 131a of the housing, the positioning pin 140 is secured to the lower housing 10b in a posture parallel to the Z direction. However, when the positioning pin 140 is secured to the positioning hole 131a of the housing by press-fitting, there are the following problems. That is, when the positioning pin 140 is secured by press-fitting into the positioning hole 131a of the housing, a residual stress is generated in the positioning pin 140. As a result, the positioning pin 140 may be deformed due to release of the residual stress of the positioning pin 140 by heating of the diffusion bonding. In the case of fixing by press fitting, deformation of the positioning pin 140 due to thermal expansion of the positioning pin 140 due to heating at the time of the diffusion bonding or release of residual stress of the positioning pin 140 cannot be released in the positioning hole 131a. As a result, the positioning hole 131a itself of the housing may be deformed. As described above, when the positioning pin is secured by press fitting, the positioning pin and the positioning holes 131a and 131b may be deformed, the positioning accuracy may deteriorate, and the concentricity shift between the nozzle and the needle valve may deteriorate.

On the other hand, in Example 1, a predetermined gap is provided between the positioning hole 131a of the housing and the positioning pin 140, and the positioning pin 140 is secured to the positioning hole 131a of the housing by the fixing member 160a screwed into the female screw portion 150a. As described above, since the fixing is not performed by press-fitting, the residual stress is hardly generated in the positioning pin 140. Thus, deformation of the positioning pin 140 is favorably prevented by the release of the residual stress of the positioning pin 140 due to the heating of the diffusion bonding.

Since there is a gap between at least the positioning hole 131a and the positioning pin 140 in the Y direction, thermal expansion of the positioning pin 140 due to heating of the diffusion bonding can be released. Thus, deformation of the positioning hole 131a and deformation of the positioning pin can be prevented as compared with press fitting with no escape place at all due to the thermal expansion of the positioning pin 140 in the positioning hole of the housing. Thus, deterioration in positioning accuracy can be prevented, and a concentricity shift between the nozzle and the needle valve can be kept within a prescribed range.

On the other hand, the sub-reference positioning hole 130b of the nozzle plate has a longer diameter than the main reference positioning hole 130a. Thus, at the time of temperature rise of the diffusion bonding, contact of the sub-reference positioning hole 130b with the positioning pin 140 due to thermal expansion of the nozzle plate 101 is prevented.

The positioning pin 140 inserted into the sub-reference positioning hole 130b of the nozzle plate 101 is not secured to the positioning hole of the housing. Thus, if the positioning pin 140 inserted into the sub-reference positioning hole 130b of the nozzle plate 101 comes into contact with the positioning pin due to thermal expansion of the nozzle plate at the time of temperature rise of the diffusion bonding, tilting of the positioning pin in the X direction or the like occurs, and the thermal expansion of the nozzle plate can be released. Thus, it is possible to prevent the occurrence of deformation such as distortion, warpage, or waviness of the nozzle plate 101. Even if the positioning pin 140 inserted into the sub-reference positioning hole 130b of the nozzle plate 101 is inclined in the X direction, the position in the X direction is accurately positioned by the positioning pin 140 inserted into the main reference positioning hole 130a, so that the positioning accuracy is not deteriorated.

At the time of temperature rise from 800° C. to 1000° C. in the diffusion bonding, the concentricity shift between the nozzle 111 and the needle valve 113 deteriorates due to a high thermal expansion speed of the nozzle plate 101.

However, the nozzle plate 101 and the lower housing 10b are made of the same material (SUS430), and have the same linear expansion coefficient. Therefore, after the temperature rise of the nozzle plate 101 and the lower housing 10b heated to the same temperature, the concentricity shift between the nozzle 111 and the needle valve 113 is eliminated, and the diffusion bonding is performed with the concentricity shift within the prescribed range.

The positioning pin 140 and the fixing member 160a are also made of the same material (SUS430) as that of the lower housing 10b, and the positioning pin 140 and the fixing member 160a have the same linear expansion coefficient as that of the lower housing 10b. Therefore, it is possible to prevent generation of stress due to a difference in thermal expansion between the fixing member and the lower housing, between the positioning pin and the fixing member, and between the positioning pin and the lower housing due to a difference in thermal expansion after temperature rise in the diffusion bonding. This makes it possible to prevent deformation of the positioning pin, the fixing member, and the lower housing at the time of the diffusion bonding. As a result, it is possible to prevent a concentricity shift between the nozzle 111 and the needle valve 113.

### Example 2

FIG. 11 is a bottom view of the nozzle plate 101 in Example 2.

Example 2 illustrated in FIG. 11 is similar to Example 1 except that the sub-reference positioning hole 130b of the nozzle plate is a long hole elongated in the X direction. The sub-reference positioning hole 130b of the nozzle plate has a length (length in the X direction) of 1.05 mm and a width (length in the Y direction) of 1.01 mm.

Since the main reference positioning hole 130a of the nozzle plate is the same as that in Example 1, the nozzle plate 101 is positioned with respect to the lower housing 10b with an accuracy of 0 to 15 μm as in Example 1.

On the other hand, on the sub-reference side, the sub-reference positioning hole 130b can narrow the gap with the positioning pin in the Y direction as compared with the round hole having a diameter of 1.05 mm. Thus, the positioning accuracy of the nozzle plate 101 around the Z direction with respect to the lower housing 10b can be enhanced as compared with Example 1.

The gap between the sub-reference positioning hole 130b of Example 2 and the positioning pin 140 in the X direction is similar to that in Example 1, and it is possible to prevent the sub-reference positioning hole 130b from abutting on the positioning pin 140 due to thermal expansion of the nozzle plate in the X direction at the time of temperature rise of the diffusion bonding as in Example 1. Thus, as in Example 1, it is possible to prevent the positioning pin 140 inserted into the sub-reference positioning hole 130b from being inclined.

The length of the sub-reference positioning hole 130b of Example 2 in the X direction is the same as that of the sub-reference positioning hole of Example 1. Therefore, in Example 2, the sub-reference positioning hole 130b hardly abuts on the positioning pin 140 due to the thermal expansion of the nozzle plate 101 in the X direction at the time of temperature rise of the diffusion bonding, as in Example 1. Thus, the thermal expansion of the nozzle plate in the X direction is not hindered by the positioning pin 140 inserted into the sub-reference positioning hole 130b, and the occurrence of distortion and deformation of the nozzle plate 101 can be prevented.

The positioning pin 140 inserted into the sub-reference positioning hole 130b is not secured. Therefore, even if the sub-reference positioning hole 130b abuts on the positioning pin 140, by the positioning pin moving or inclining in the X direction, thermal expansion of the nozzle plate in the X direction can be allowed. Thus, the occurrence of distortion and deformation of the nozzle plate 101 can be favorably prevented. Since the positioning pin inserted into the sub-reference positioning hole 130b positions the nozzle plate around the Z direction, even if the positioning pin is inclined in the X direction, the positioning accuracy is not affected.

### Example 3

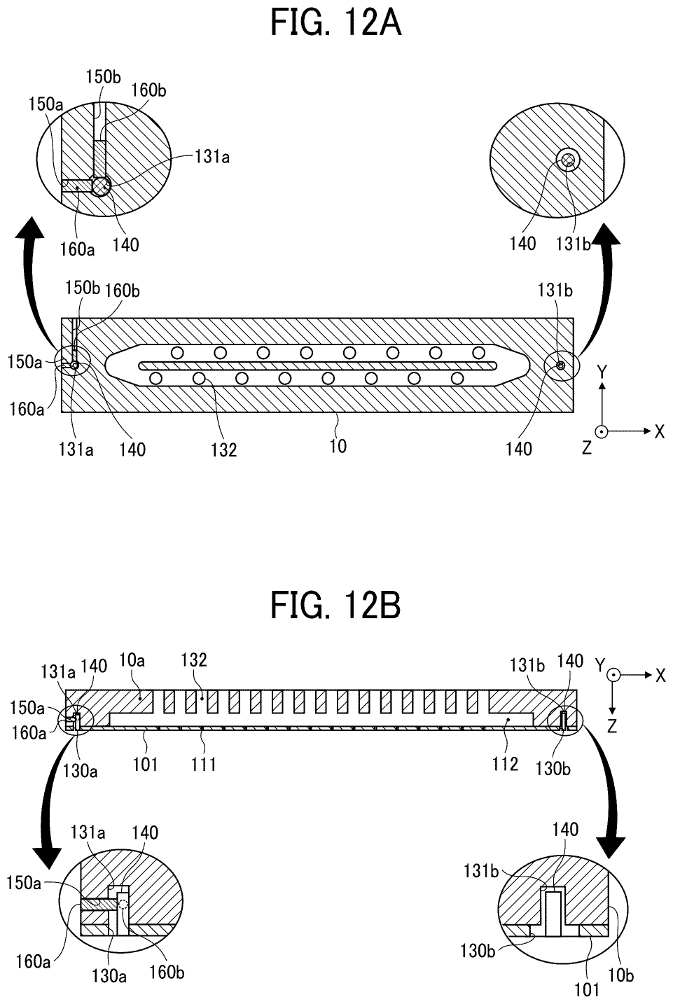

FIGS. 12A and 12B are schematic views illustrating a configuration of Example 3, FIG. 12A is a bottom view of the lower housing 10b, and FIG. 12B is a cross-sectional view of a stacked plate including the lower housing 10b and the nozzle plate 101.

In Example 3, the positioning pin 140 inserted into the main reference positioning hole 130a is clamped and secured in two directions of the X direction and the Y direction.

Specifically, the following configuration is added to the configuration of Example 1. That is, a second female screw portion 150b as a second communication hole communicating with the positioning hole 131a and a second fixing member 160b screwed into the second female screw portion 150b are provided extending in the Y direction from the side surface of the lower housing 10b orthogonal to the Y direction.

Similarly to the female screw portion 150a extending in the X direction, the second female screw portion 150b is of M1.6 with a pitch of 0.35 mm, and is obtained by forming a communication hole by drilling and then forming a screw groove in the inner peripheral surface by tapping.

The position of the second female screw portion 150b is 3 mm in the +X-axis direction from a side end of the positioning hole 131a of the side surface of the lower housing orthogonal to the Y direction, and 1.5 mm in the +Z-axis direction from the housing bottom surface.

Similarly to the fixing member 160a, the second fixing member 160b is a hexagon socket set screw of SUS430 of M1.6×0.35 mm with a length of 3 mm. Note that the material of the second fixing member 160b is not limited to the above material and size, and the material may be, for example, stainless steel other than SUS430, and it is sufficient if a size corresponding to the nominal diameter of the second female screw portion 150b is selected as the hexagon socket set screw.

As the tip shape of the second fixing member 160b, for example, a shape similar to that of the fixing member 160a, such as a pointed tip or a bar tip, can be adopted.

The second fixing member 160b is screwed into the second female screw portion 150b, and the positioning pin 140 inserted into the positioning hole 131a of the housing is pushed in the Y direction by the tip protrude from the second female screw portion 150b. By being pushed by the second fixing member 160b, the positioning pin 140 is pressed against the inner peripheral surface of the positioning hole 131a on the side opposite to the second female screw portion side. Thus, the positioning pin 140 is clamped and secured in the Y direction between the second fixing member 160b and the inner peripheral surface of the positioning hole 131a.

As in Example 1, the positioning pin 140 in the positioning hole 131a is pushed in the X direction by the fixing member 160a. Accordingly, the positioning pin 140 is also clamped and secured in the X direction by the fixing member 160a and the inner peripheral surface on the inner side in the X direction of the positioning hole 131a.

As described above, in Example 3, the positioning pin is clamped and secured in the X direction and the Y direction, so that the positioning pin is firmly secured in the positioning hole 131a of the housing in a posture parallel to the Z direction. Thus, it is possible to prevent the inclination of the positioning pin due to the thermal expansion of the nozzle plate at the time of temperature rise of the diffusion bonding as compared with Example 1, and it is possible to maintain the posture parallel to the Z direction.

On the other hand, since Example 1 has more escape places when the positioning pin is thermally expanded than Example 3, there is an advantage that deformation of the positioning hole 131a and deformation of the positioning pin can be prevented as compared with Example 3. There is also an advantage that the number of components is small and the cost of the device can be reduced as compared with the third embodiment.

### Example 4

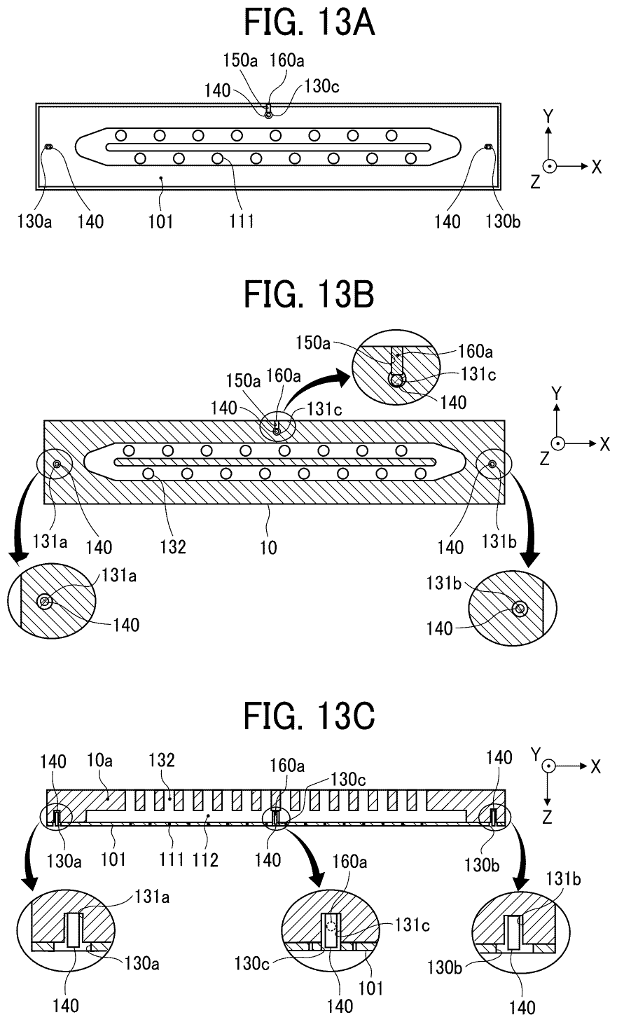

FIGS. 13A to 13C are schematic views illustrating a configuration of Example 4. FIG. 13A is a bottom view of the stacked plate including the lower housing 10b and the nozzle plate 101, and FIG. 13B is a cross-sectional view of the lower housing perpendicular to the Z direction. FIG. 13C is a cross-sectional view perpendicular to the Y direction of the stacked plate including the lower housing 10b and the nozzle plate 101.

In Example 4, the nozzle plate 101 is positioned in the lower housing at a total of three positions of both ends and a central portion in the X direction. The main reference positioning hole 130a and the sub-reference positioning hole 130b at both ends in the X direction of the nozzle plate are sub-references for positioning, and are long holes having a length (length in the X direction) of 1.05 mm and a width (length in the Y direction) of 1.01 mm. On the other hand, the main reference positioning hole 130c at the center in the X direction is a main positioning reference and is a round hole having a diameter of 1.01 mm.

Here, it is sufficient if the central portion in the X direction is substantially near the center in the X direction of the nozzle plate 101 and, for example, in a region between positioning holes at both ends in the X direction. Alternatively, the central portion may be a range in which the nozzles 111 are arranged in the X direction.

The main reference positioning hole 130a and the sub-reference positioning hole 130b at both ends in the X direction are at the center in the Y direction of the nozzle plate 101, and the main reference positioning hole 130a and the sub-reference positioning hole 130b at the center in the X direction are at one end (+Y direction side end) in the Y direction.

As illustrated in FIG. 13B, positioning holes 131a, 131b, and 131c are provided at positions corresponding to the main reference positioning hole 130a, the sub-reference positioning hole 130b, and the main reference positioning hole 130c of the nozzle plate 101 of the lower housing 10b. The positioning holes 131a and 131b at both ends in the X direction of the housing are round holes having a diameter of 1.05 mm, and the positioning hole 131c at the center in the X direction of the housing is a round hole having a diameter of 1.01 mm. The positioning pin inserted into each positioning hole has a diameter of 0.995 mm and is made of stainless steel (SUS430) as in Example 1.

Among two side surfaces perpendicular to the Y direction of the lower housing 10b, a female screw portion 150a as a communication hole is provided at a center portion in the X direction of a side surface on the positioning hole 131c side at a center portion in the X direction. The female screw portion 150a extends in the Y direction and communicates with the main reference positioning hole 130c at the center.

The female screw portion 150a is of M1.6×0.35 mm with a length of 2.5 mm as in Example 1. After the communication hole is formed by drilling, the female screw portion 150a is tapped to form a thread groove.

The center of the female screw portion 150a is located at a position of 1.5 mm in the −Z direction from the bottom surface of the lower housing 10b at the center of the lower housing 10b in the X direction.

The fixing member 160a that can be screwed into the female screw portion 150a is a hexagon socket set screw of stainless steel (SUS430) of M1.6 with a pitch of 0.35 mm as in Example 1.

The fixing member 160a is screwed into the female screw portion 150a, and the positioning pin 140 inserted into the positioning hole 131c of the housing is pushed in the Y direction by the tip protruding from the female screw portion 150a. By being pushed by the fixing member 160a, the positioning pin 140 is pressed against the inner peripheral surface of the positioning hole 131c, and the positioning pin 140 is clamped and secured in the Y direction between the fixing member 160a and the inner peripheral surface of the positioning hole 131c.

Since the diameter of the main reference positioning hole 130c of the nozzle plate and the diameter of the positioning pin 140 are the same as the diameters in Example 1, also in Example 4, the nozzle plate can be positioned in the lower housing with the same positioning accuracy as in Example 1.

The positioning pin inserted into the main reference positioning hole 130c is clamped and secured in a posture parallel to the Z direction between the fixing member and the inner peripheral surface of the positioning hole of the housing. Therefore, even in Example 4, it is possible to prevent the positioning pin 140 from being inclined due to thermal expansion of the nozzle plate at the time of temperature rise of the diffusion bonding, and it is possible to prevent deterioration of positioning accuracy. Thus, the concentricity shift between the nozzle and the needle valve can be kept within the prescribed range.

In Example 4, the main reference positioning hole 130a and the sub-reference positioning hole 130b at both ends in the X direction of the nozzle plate are sub-references for positioning, and are long holes elongated in the X direction. The thermal expansion of the nozzle plate in the X direction at the time of temperature rise of the diffusion bonding increases toward the end portion in the X direction. Therefore, by making the main reference positioning hole 130a and the sub-reference positioning hole 130b at both ends in the X direction of the nozzle plate as long holes elongated in the X direction as a sub-reference for positioning, the thermal expansion of the nozzle plate in the X direction at the time of temperature rise of the diffusion bonding can be favorably allowed as compared with the case where one end portion in the X direction is set as a main reference for positioning. Accordingly, the occurrence of distortion of the nozzle plate 101 can be favorably prevented.

By providing the main reference positioning hole of the nozzle plate at the central portion in the X direction where the thermal expansion of the nozzle plate in the X direction at the time of temperature rise of the diffusion bonding is smaller than that of the end portions in the X direction, the load in the X direction applied to the positioning pin inserted into the main reference positioning hole is reduced by the thermal expansion of the nozzle plate. Thus, it is possible to favorably prevent the inclination of the positioning pin due to thermal expansion of the nozzle plate at the time of temperature rise of the diffusion bonding, and it is possible to prevent deterioration of positioning accuracy. Thus, the concentricity shift between the nozzle and the needle valve can be favorably kept within the prescribed range.

The concentricity between the nozzle and the needle valve was evaluated for Examples 1 to 4 described above and Comparative Examples 1 to 3 described below.

### Comparative Example 1

In Comparative Example 1, in Example 1, the fixing member 160a is removed, and the positioning pin 140 is not secured in the positioning hole of the housing.

### Comparative Example 2

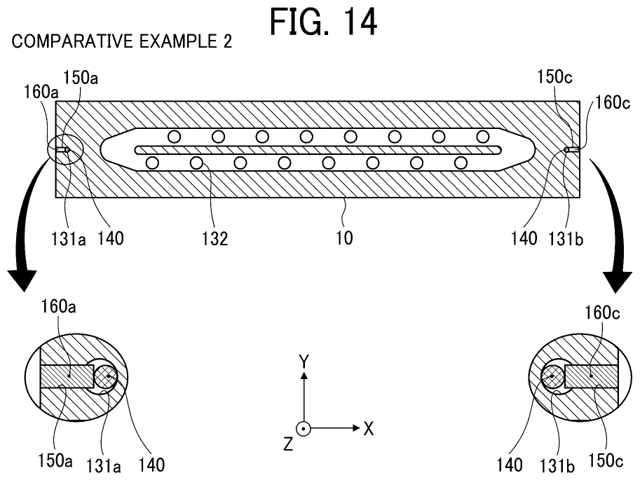

In Comparative Example 2, as illustrated in FIG. 14, the positioning pin 140 inserted into the positioning hole 131b as a sub-reference positioning hole of the nozzle plate 101 is also secured by a fixing member 160c. Specifically, a female screw portion 150c extending in the X direction and communicating with the positioning hole 131b is provided on a side surface of the housing on the positioning hole 131b side orthogonal to the X direction. Then, the fixing member 160c is screwed into the female screw portion 150c, and the positioning pin 140 inserted into the positioning hole 131b is pushed inward in the X direction to be clamped and secured between the fixing member 160c and the inner peripheral surface of the positioning hole 131c. Shapes, materials, and the like of the female screw portion 150c and the fixing member 160c are the same as the shapes, materials, and the like of the female screw portion 150a on the positioning hole 131a side and the fixing member 160a screwed into the female screw portion 150a.

### Comparative Example 3

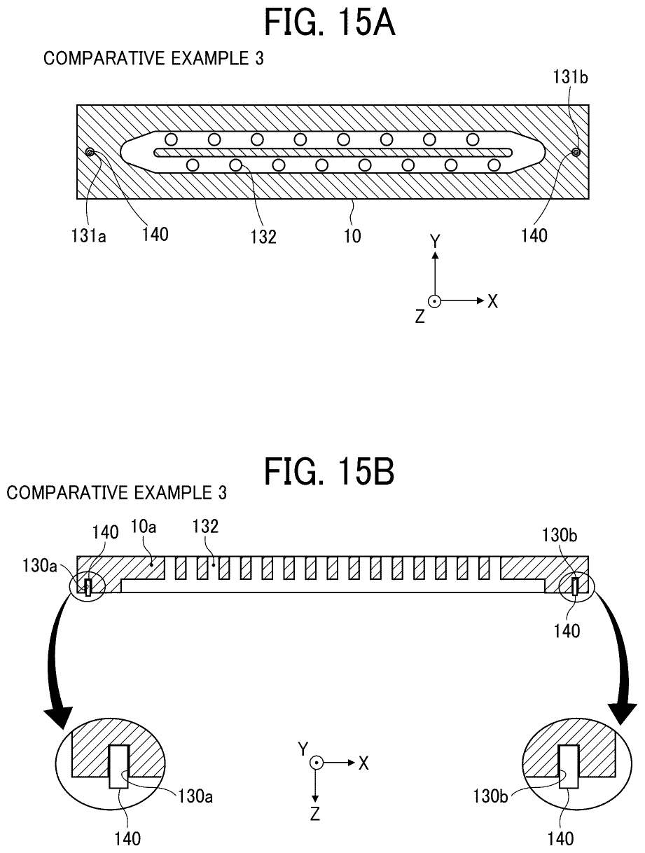

In Comparative Example 3, as illustrated in FIGS. 15A and 15B, a positioning pin is press-fitted into a positioning hole of a housing.

The concentricity shift between the nozzle 111 and the needle valve 113 was evaluated by measuring the positional shift amount between the lower housing 10b and the nozzle plate 101. The concentricity shift between the needle valve 113 and the nozzle 111 is a stack of joining accuracy (positional shift amount) between the nozzle plate 101 and the lower housing 10b, joining accuracy between the lower housing 10b and the upper housing 10a, and assembling accuracy (accuracy of the bearing 121) of the needle valve 113 to the upper housing 10a. If the joining accuracy between the lower housing 10b and the upper housing 10a and the assembling accuracy of the needle valve 113 to the upper housing 10a are predetermined accuracy, an allowable range of the amount of positional shift between the lower housing 10b and the nozzle plate 101 is determined. In the present embodiment, when the amount of positional shift between the lower housing 10b and the nozzle plate 101 is equal to or less than 15 μm, the concentricity shift is evaluated as “good”. On the other hand, when the amount of positional shift between the lower housing 10b and the nozzle plate 101 was more than 15 μm and equal to or less than 25 μm, the concentricity shift was evaluated as “possible”. On the other hand, when the amount of positional shift between the lower housing 10b and the nozzle plate exceeded 25 μm, the concentricity shift evaluation was evaluated as “failed”.

The positional shift amount between the nozzle plate 101 and the lower housing 10b was measured using a CNC image measurement device (QV-H302T1S-D). The measurement procedure is as follows.
(1) A joint body including the nozzle plate 101 and the lower housing with the nozzle plate 101 as an upper surface is set in the CNC image measurement device.
(2) Next, the CNC image measurement device acquires the center points for all the valve through holes 132 and the nozzles on the bottom surface of the lower housing.
(3) Next, for all the valve through holes 132, the shift amount of the center point of the nozzle 111 at the same position as the center point of the valve through hole 132 is calculated.
(4) The maximum shift amount from the calculated shift amounts of all the center points is defined as a shift amount between the nozzle plate 101 and the lower housing 10b.

Table 1 below illustrates evaluation results of the concentricity shift between the nozzle 111 and the needle valve 113 of Examples 1 to 4 and Comparative Examples 1 to 3.

TABLE 1

| | Structure of plate stack | *Concentricity |
|---|---|---|
| Example 1 | Positioning holes on both ends of nozzle plate: ϕ1.01 round | Fair |
| | hole and ϕ1.05 round hole | |
| | Fixed member: one in positioning hole being ϕ1.01 round hole | |
| Example 2 | Positioning holes on both ends of nozzle plate: ϕ1.01 round | Fair |
| | hole and ϕ1.01 × ϕ1.05 mm long hole | |
| | Fixed member: one in positioning hole being ϕ1.01 round hole | |
| Example 3 | Positioning holes on both ends of nozzle plate: ϕ1.01 round | Good |
| | hole and ϕ1.01 × ϕ1.05 mm long hole | |
| | Fixed member: two in positioning hole being ϕ1.01 round hole | |
| | (in X and Y axis directions) | |
| Example 4 | Three positioning holes: ϕ1.01 center round hole and ϕ1.01 × | Good |
| | ϕ1.05 mm long holes on both ends | |
| | Fixed member: one in positioning hole being ϕ1.01 center | |
| | round hole | |
| Comparative | Positioning holes on both ends of nozzle plate: ϕ1.01 round | Fail |
| Example 1 | hole and ϕ1.05 round hole | There are inclination and |
| | Fixed member: none | deformation of positioning |
| | | member during joining |
| Comparative | Positioning holes on both ends of nozzle plate: ϕ1.01 round | Fail |
| Example 2 | hole and ϕ1.05 round hole | Deformation (waviness) |
| | Fixed member: one each in positioning hole ϕ1.01 round hole | occurs on nozzle plate |
| | and ϕ1.05 round hole | surface |
| Comparative | Joining using housing in which positioning member is press- | Fail |
| Example 3 | fitted in each of positioning holes being ϕ1.01 round hole and | Deformation of positioning |
| | ϕ1.05 round hole on both ends of nozzle plate | member/positioning hole |
| | | occurs |

As illustrated in Table 1, in Comparative Example 1, the positional shift amount between the lower housing 10b and the nozzle plate 101 exceeded 25 μm, and the concentricity shift evaluation was “fail”. Regarding Comparative Example 1, after the diffusion bonding, the positioning pin 140 inserted into the main reference positioning hole 130a of the nozzle plate 101 was confirmed, and the positioning pin 140 was inclined. Deformation of the positioning pin 140 was also confirmed.

In Comparative Example 1, the positioning pin 140 inserted into the main reference positioning hole 130a of the nozzle plate is not secured. As a result, it is conceivable that the positioning pin 140 inserted into the main reference positioning hole 130a of the nozzle plate was pushed into the nozzle plate 101 and inclined due to thermal expansion of the nozzle plate at the time of temperature rise of the diffusion bonding. When the positioning pin 140 is inclined, the edge of the main reference positioning hole 130a of the nozzle plate 101 and the edge of the positioning hole 131a of the housing are brought into point contact with the positioning pin 140. As a result, a stress concentration portion is generated in the positioning pin 140. Thus, in a state where the positioning pin is easily deformed due to heating during the diffusion bonding, it is conceivable that a stress concentration portion is generated in the positioning pin 140, and thereby the positioning pin 140 was deformed. As described above, it is conceivable that the positioning pin 140 inserted into the main reference positioning hole 130a of the nozzle plate was inclined and deformed, and thereby the positional shift amount between the lower housing 10b and the nozzle plate exceeded 25 μm, resulting in the concentricity shift evaluation of “fail”.

Also in Comparative Example 2, the positional shift amount between the lower housing 10b and the nozzle plate exceeded 25 μm, and the concentricity shift evaluation was “fail”. When the nozzle plate was confirmed after the diffusion bonding, corrugated deformation was confirmed in the X direction.

In Comparative Example 2, the positioning pin 140 inserted into a sub-reference positioning hole 130a of the nozzle plate is also secured to the fixing member. The positioning pin 140 inserted into a sub-reference positioning hole 130a of the nozzle plate is secured to be close to the inner side in the X direction. As a result, the inner end in the X direction of the sub-reference positioning hole of the nozzle plate abuts on the positioning pin when the temperature of the nozzle plate rises at the time of temperature rise of the diffusion bonding, and thermal expansion of the nozzle plate in the X direction is restricted by the positioning pins at both ends. Thus, it is conceivable that there is no escape place of thermal expansion of the nozzle plate in the X direction, and the nozzle plate that is easily deformed by heating of the diffusion bonding is deformed so as to be wavy. As a result, it is conceivable that the positional shift amount between the lower housing 10b and the nozzle plate exceeded 25 μm, and the concentricity shift evaluation was “fail”.

Also in Comparative Example 3, the positional shift amount between the lower housing 10b and the nozzle plate exceeded 25 μm, and the concentricity shift evaluation was “fail”. When the positioning pin inserted into a sub-reference positioning hole 130a of the nozzle plate was confirmed after the diffusion bonding, deformation was observed in the positioning pin. Deformation was also confirmed in the positioning hole 131a corresponding to the main reference positioning hole 130a of the housing.

In Comparative Example 3, since the positioning pin is secured to the positioning hole of the housing by press-fitting, a residual stress is generated in the positioning pin press-fitted into the housing. As a result, it is conceivable that the positioning pin was deformed when the residual stress of the positioning pin was released by heating during the diffusion bonding. Since there is no gap between the positioning hole of the housing and the positioning hole, there is no escape of thermal expansion of the positioning pin due to heating at the time of the diffusion bonding. As a result, it is conceivable that the positioning hole which is easily deformed by heating during the diffusion bonding is deformed by the pressure of thermal expansion of the positioning pin. As described above, due to the deformation of the positioning pin and the deformation of the positioning hole of the housing, it is conceivable that the positional shift amount between the lower housing 10b and the nozzle plate exceeded 25 μm, and the concentricity displacement evaluation was “fail”.

On the other hand, in all of Examples 1 to 4, the positional shift amount between the lower housing 10b and the nozzle plate was equal to or less than 25 μm, and a good result in the concentricity shift evaluation was obtained. In Examples 1 to 4, the positioning pin 140 inserted into the main reference positioning hole 130a of the nozzle plate is secured in a posture parallel to the Z direction by a fixing member. Thus, unlike Comparative Example 1, the inclination of the positioning pin 140 inserted into the main reference positioning hole 130a of the nozzle plate was prevented, and deterioration in positioning accuracy was prevented.

In Examples 1 to 4, unlike Comparative Example 3, there is a clearance for releasing thermal expansion of the positioning pin between the positioning pin and the positioning hole of the housing, and no residual stress occurs in the positioning pin. Thus, deformation of the positioning pin and deformation of the positioning hole of the housing can be favorably suppressed.

Further, unlike Comparative Example 2, in any of Examples 1 to 4, the positioning pin 140 inserted into the sub-reference positioning hole 130b of the nozzle plate is not secured. Therefore, the thermal expansion of the nozzle plate in the X direction is not restricted by the positioning on both sides in the X direction. Thus, a wavy deformation does not occur in the nozzle plate.

Therefore, it is conceivable that, in all of Examples 1 to 4, the positional shift amount between the lower housing 10b and the nozzle plate was equal to or less than 25 μm, and good results in the concentricity shift evaluation were obtained.

In particular, in Example 3 in which the positioning pin 140 inserted into the main reference positioning hole of the nozzle plate was clamped and secured in two directions of the X direction and the Y direction, the positioning pin was firmly secured in a posture parallel to the Z direction, and the inclination of the positioning pin 140 inserted into the main reference positioning hole was favorably prevented. As a result, the positional shift amount between the lower housing 10b and the nozzle plate was suppressed to be equal to or less than 15 μm, and the concentricity shift evaluation was determined as “good”.

In Example 4, the concentricity shift evaluation was “good”. In Example 4, the main reference positioning hole 130a and the sub-reference positioning hole 130b at both ends in the X direction of the nozzle plate are set as long holes elongated in the X direction as a sub-reference for positioning, and the main reference positioning hole 130c at the center in the X direction of the nozzle plate is set as a main reference for the positioning hole. Then, the positioning pin inserted into the main reference positioning hole 130c at the center in the X direction of the nozzle plate is secured in a posture parallel to the Z direction by a fixing member. As described above, since the main reference positioning hole 130a and the sub-reference positioning hole 130b at both ends of the nozzle plate in the X direction are set as long holes which are long in the X direction, it is conceivable that thermal expansion of the nozzle plate in the X direction at the time of temperature rise of the diffusion bonding can be favorably permitted. As a result, the occurrence of distortion of the nozzle plate 101 can be favorably prevented, and the positional shift amount from the nozzle plate can be prevented to be equal to or less than 15 μm. Thus, the concentricity shift evaluation is considered to be “good” determination.

The liquid discharge head described above is a valve jet type, and can discharge a highly viscous liquid or a large droplet (a diameter of several tens to several hundred μm) toward a discharge target object at a distance (several tens mm ahead). The nozzle diameter can be increased, and a liquid or the like containing a material having a large particle diameter can be favorably discharged. As described above, since a highly viscous liquid can be discharged, the liquid discharge head described above is suitable for painting a vehicle body of a vehicle or a truck, a body of an aircraft, a wall surface of a building, a road surface, and the like, and printing an image. It can also be suitably used for forming an electrode such as a lithium ion battery mounted on a vehicle body.

Next, an example of a liquid discharge apparatus including the liquid discharge head 1 will be described.

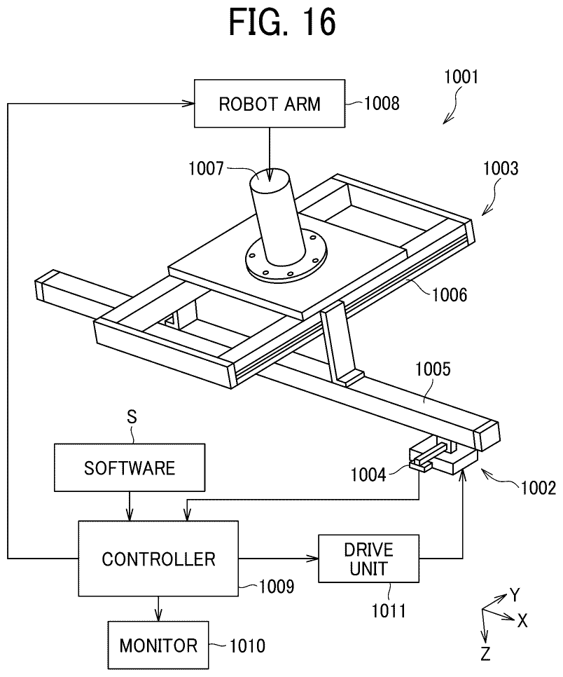

FIG. 16 is a schematic configuration diagram of an inkjet printer as a liquid discharge apparatus.

The inkjet printer 1001 includes a liquid discharge unit 1002 including a liquid discharge head, and a camera 1004 as an imaging unit disposed near the liquid discharge unit 1002. An X-Y table 1003 as a scan moving mechanism that moves the liquid discharge unit 1002 and the camera 1004 in the X direction and the Y direction is provided. The scan moving mechanism is referred to also as “a scanner” to move the liquid discharge unit 1002 and the camera 1004 in the X direction and the Y direction.

The inkjet printer 1001 further includes a controller 1009. The controller 1009 operates the X-Y table 1003 on the basis of image editing software for editing an image captured by the camera 1004 and a preset control program to discharge ink from the liquid discharge unit 1002 and control printing on a printed surface. The inkjet printer 1001 includes a drive unit 1011 that positions the camera 1004 and the liquid discharge unit 1002 at predetermined positions on the basis of the control from the controller 1009 to perform image capturing and printing operations.

The liquid discharge unit 1002 includes a plurality of liquid discharge heads that discharges ink toward a surface to be coated of an object to be coated M. Note that, the term “ink” as used herein also includes “paint”. A nozzle surface of the liquid discharge head is parallel to an X-Y plane formed by movement of the X-Y table 1003, and ink dots discharged from each nozzle are discharged in the Z direction perpendicular to the X-Y plane.

Each of the plurality of liquid discharge heads included in the liquid discharge unit 1002 is coupled to an ink tank of a predetermined color, and the ink tank is pressurized by a pressurizing device. Ink in the ink tank is supplied from the supply port 11 (see FIG. 1) of the liquid discharge head, and ink discharged from the collection port 12 (see FIG. 1) of the liquid discharge head is collected in the ink tank.

If the distance between the nozzle surface of the liquid discharge head and a print surface of the object to be coated M is about 20 cm, the ink dots can be discharged onto the print surface of the object to be coated M without any problem.

The X-Y table 1003 includes a Y-axis rail 1005 provided with a linear movement mechanism, and an X-axis movement mechanism 1006 that moves the Y-axis rail 1005 in the X direction while holding the Y-axis rail 1005 with two arms.

The liquid discharge unit 1002 and the camera 1004 to be described later are attached to a slider held by the Y-axis rail 1005. The X-axis movement mechanism 1006 is provided with a shaft 1007, and the shaft 1007 is held by a robot arm 1008. The robot arm allows the liquid discharge unit 1002 to be freely disposed at a predetermined position where printing is to be performed on the object to be coated M.

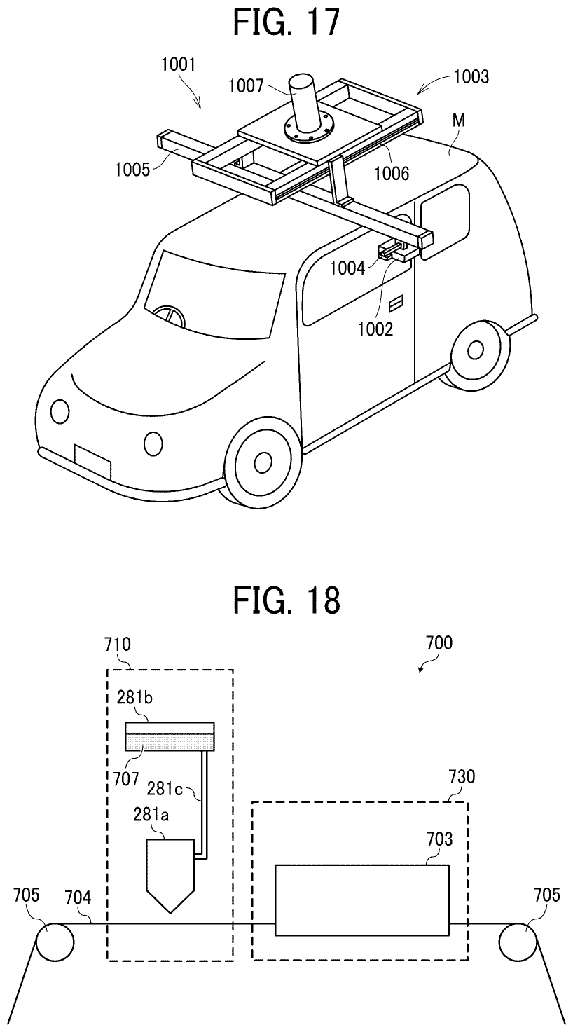

For example, when the object to be coated M is an automobile, the object to be coated M can be disposed on an upper portion as illustrated in FIG. 17 or can be disposed at a lateral position by the robot arm 1008. Note that, the operation of the robot arm 1008 is controlled on the basis of a program stored in advance in the controller 1009.

The camera 1004 is disposed on a slider of the Y-axis rail 1005 near the liquid discharge unit 1002, and captures an image of a predetermined range of the printed surface of the object to be coated M at constant minute intervals while moving in the X-Y direction. The camera 1004 is a so-called digital camera, and as described above, specifications of a lens with which a plurality of subdivided images can be captured in the predetermined range of the printed surface, specifications of resolution, and the like are appropriately selected. The plurality of subdivided images of the printed surface is continuously and automatically captured by the camera 1004 according to a program provided in advance in the controller 1009.

The controller 1009 includes a storage device that records and stores various programs, data of captured images, data of images to be printed, and the like, and a central processing unit that executes various types of processing according to the programs. The controller 1009 is configured by a so-called microcomputer including an input device such as a keyboard and a mouse, and a DVD player as necessary.

The inkjet printer 1001 further includes a monitor 1010, and displays input information to the controller 1009, a processing result by the controller 1009, and the like.

The controller 1009 performs image processing on a plurality of pieces of subdivided image data captured by the camera 1004 using image processing software, and generates a composited print surface obtained by projecting the printed surface of the object to be coated M, which is not a flat surface, onto a flat surface to be described later. The controller 1009 edits an image to be drawn in the following manner to generate an edited image to be drawn. That is, this superimposes the image to be drawn, which is the image that should be printed so as to be continuous to the image already printed on the printed surface on the composited print surface, and edits the image to be drawn so as to be continuous to an edge portion of the printed image.

For example, for the image to be drawn, the drawing target image is edited (deformed) so as to be aligned with the composited print surface so that a non-print region is not present between the image to be drawn and the adjacent image to be drawn, thereby generating an edited image to be drawn. Then, printing is actually performed by the liquid discharge unit 1002 on the basis of the edited image to be drawn. Thus, a print image can be printed without a gap from a printed print image. Note that, the operation of capturing the plurality of subdivided images by the camera 1004 and printing by discharging ink from the nozzle of each liquid discharge head of the liquid discharge unit 1002 is performed by the drive unit 1011 of which operation is controlled by the controller 1009.

FIG. 18 is a diagram illustrating an example of an electrode manufacturing apparatus 700 as a liquid discharge apparatus including the liquid discharge head according to the present embodiment.

The electrode manufacturing apparatus 700 includes a discharge process unit 710 that performs a process of applying a liquid composition onto a printing base material 704 including a discharge target to form a liquid composition layer, and a heating process unit 730 that performs a heating process of heating the liquid composition layer to obtain an electrode mixture layer.

The printing base material 704 on which the liquid composition layer is formed is not particularly limited as long as this is a target on which a layer including an electrode material is formed, and can be appropriately selected according to an object. For example, there is an electrode substrate (current collector), an active material layer, and a layer including a solid electrode material.

The discharge process unit 710 may directly discharge the liquid composition to form the layer including the electrode material as long as this can form the layer including the electrode material on the printing base material 704. It is possible to indirectly discharge the liquid composition to form the layer including the electrode material.

The heating process unit 730 is a process of heating the liquid composition discharged onto the printing base material 704 in the discharge process unit 710. The liquid composition layer can be dried by heating.

The electrode manufacturing apparatus 700 is provided with a conveyance unit 705 that conveys the printing base material 704, and the conveyance unit 705 conveys the printing base material 704 at a preset speed in an order of the discharge process unit 710 and the heating process unit 730. A method for manufacturing the printing base material 704 having the discharge target such as an active material layer is not particularly limited, and a known method can be appropriately selected. The discharge process unit 710 includes a printing apparatus 281a including the liquid discharge head 1 of the present embodiment that discharges the liquid composition onto the printing base material 704. The discharge process unit 710 also includes a storage container 281b that stores a liquid composition, and a supply tube 281c that supplies the liquid composition stored in the storage container 281b to the printing apparatus 281a.

The storage container 281b stores a liquid composition 707, and the discharge process unit 710 discharges the liquid composition 707 from the printing apparatus 281a to apply the liquid composition 707 onto the printing base material 704 to form a liquid composition layer in a thin film shape. The storage container 281b may be integrated with the manufacturing apparatus for the electrode mixture layer, or may be detachable from the manufacturing apparatus for the electrode mixture layer. The container may be used to be added to a storage container integrated with the manufacturing apparatus for the electrode mixture layer or a storage container detachable from the manufacturing apparatus for the electrode mixture layer.

The storage container 281b and the supply tube 281c can be arbitrarily selected as long as the liquid composition 707 can be stably stored and supplied to the liquid discharge head 1.

The heating process unit 730 includes a heater 703, and includes a solvent removal process of heating and drying a solvent remaining in the liquid composition layer by the heater 703 to remove. Thus, the electrode mixture layer can be formed. The heating process unit 730 may perform a solvent removal process under reduced pressure.

The heater 703 is not particularly limited, and can be appropriately selected according to a purpose, and examples thereof include a substrate heater, an IR heater, and a warm air heater, and they may be combined. Heating temperature and time can be appropriately selected according to a boiling point of the solvent included in the liquid composition 707 and a film thickness to be formed.

When the liquid discharge head 1 of the present embodiment is used as the electrode manufacturing apparatus 700, the liquid composition can be discharged to a target place of the discharge target. The electrode mixture layer can be suitably used as, for example, a part of the configuration of an electrochemical element. The configuration other than the electrode mixture layer in the electrochemical element is not particularly limited, and a known configuration can be appropriately selected, and examples thereof include a positive electrode, a negative electrode, and a separator, for example.

Although the present embodiment has been described above, the present embodiment is not limited to the above-described embodiment, and various modifications can be made without departing from the gist of the present embodiment.

In the above description, an example in which the drive control device applies a voltage to a drive body such as a piezoelectric element to open and close the needle valve 113 has been described. However, the present embodiment is not limited thereto, and the needle valve 113 may be opened and closed by pneumatic pressure or hydraulic pressure. In this case, the drive pulse generated by the drive control device is a drive waveform for driving the pressurizing mechanism by pneumatic pressure or hydraulic pressure with a set pressure.

In the present application, the “liquid discharge apparatus” is an apparatus provided with the liquid discharge head or the liquid discharge unit obtained by integrating functional parts and mechanisms with the liquid discharge head, the apparatus that drives the liquid discharge head to discharge the liquid. The integration includes a combination in which the liquid discharge head and the functional parts and mechanisms are secured to each other through fastening, bonding, and engaging, and a combination in which one is movably held by the other. The liquid discharge head may be detachably attached to the functional parts and mechanisms.

Examples of the liquid discharge unit include a device in which a liquid discharge head and a head tank are integrated, and a device in which the liquid discharge head and the head tank are coupled to each other by a tube or the like to be integrated. Here, a unit including a filter may be added between the liquid discharge head and the head tank of the liquid discharge unit.

Examples of the liquid discharge unit include a device in which the liquid discharge head and the carriage are integrated, and a device in which the liquid discharge head, the carriage, and the scan moving mechanism are integrated. Examples of the liquid discharge unit include the liquid discharge unit in which the liquid discharge head is movably held by a guide member that forms a part of the scan moving mechanism, and the liquid discharge head and the scan moving mechanism are integrated.

Examples of the liquid discharge unit include the liquid discharge unit in which a cap member as a part of a maintenance recovery mechanism is secured to the carriage to which the liquid discharge head is attached, and the liquid discharge head, the carriage, and the maintenance recovery mechanism are integrated. Examples of the liquid discharge unit include the liquid discharge unit in which a tube is connected to the liquid discharge head to which the head tank or flow path parts are attached, and the liquid discharge head and a supply mechanism are integrated. A liquid in a liquid reservoir source is supplied to the head through this tube.

The scan moving mechanism includes a guide member single body. The supply mechanism includes a tube single body and a loading unit single body.

The “liquid discharge apparatus” may be, for example, an apparatus that can discharge a liquid to a material to which liquid can adhere or an apparatus to discharge liquid toward gas or into liquid.

The “liquid discharge apparatus” may include a unit regarding feeding, conveyance, and ejection of a material on which liquid can adhere, a pretreatment apparatus, and a post-treatment apparatus.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The “liquid discharge apparatus” is not limited to an apparatus to discharge liquid to visualize meaningful images, such as letters or figures. For example, the liquid discharge apparatus may be an apparatus to form meaningless images, such as meaningless patterns, or fabricate three-dimensional images.

The “material on which liquid can adhere” is the above-described liquid discharge target, and means a medium to which the liquid can at least temporarily adhere and to which the liquid adheres and fixes, a medium to which the liquid adheres and permeates, or the like. Examples of the “material on which liquid can adhere” include recording media, such as paper sheet, recording paper, recording sheet of paper, film, and cloth, electronic component, such as electronic substrate and piezoelectric element, and media, such as powder layer, organ model, and testing cell. The “material on which liquid can adhere” includes any material on which liquid can adhere, unless particularly limited.

Examples of the “material onto which liquid can adhere” include any materials on which liquid can adhere even temporarily, such as paper, thread, fiber, fabric, leather, metal, plastic, glass, wood, and ceramic.

The “liquid discharge apparatus” may be an apparatus to relatively move the head and a material on which liquid can adhere. However, the liquid discharge apparatus is not limited to such an apparatus. Specific examples include a serial type apparatus that moves the head unit, and a line type apparatus that does not move the head unit.

Examples of the “liquid discharge apparatus” further include a treatment liquid coating apparatus to discharge a treatment liquid to a sheet to coat the treatment liquid on a sheet surface to reform the sheet surface.

Further, there is an injection granulation apparatus for spraying a composition liquid in which raw materials are dispersed in a solution through a nozzle to granulate fine particles of the raw material.

Although preferred embodiments of the present embodiment have been described above, the present embodiment is not limited to such specific embodiments. Unless particularly limited in the above description, various modifications and changes can be made without departing from the scope of the gist of the present embodiment recited in claims.

For example, the present embodiment can also be used for joining the nozzle plate 101 and the lower housing 10b with a thermosetting adhesive. When the nozzle plate 101 and the lower housing 10b are joined with such a thermosetting adhesive, the stacked plate including the nozzle plate 101 and the lower housing is heated to cure the thermosetting adhesive, and the nozzle plate 101 and the lower housing 10b are joined. By applying the present embodiment, it is possible to prevent the positioning pin 140 from being inclined by pushing the positioning pin due to thermal expansion of the nozzle plate 101 at the time of temperature rise. This makes it possible to prevent deterioration of positioning accuracy.

A liquid discharge head includes a nozzle plate having a nozzle from which a liquid is dischargeable in a first direction, and a first positioning hole extending in the first direction, a channel member on the nozzle plate having a channel communicating with the nozzle, a second positioning hole extending in the first direction, and a communication hole on an outer peripheral surface of the channel member, the communication hole extending in a second direction orthogonal to the first direction, a positioning member inserted into each of the first positioning hole and the second positioning hole in the first direction to position the nozzle plate relative to the channel member; and a fixing member inserted through the communication hole in the second direction, the fixing member pressing, in the second direction, an outer peripheral surface of the positioning member into contact with an inner peripheral surface of at least one of the first positioning hole or the second positioning hole. The positioning member has a predetermined gap between the positioning member and each of the first positioning hole and the second positioning hole.

The nozzle plate is joined to the channel member by diffusion bonding.

The nozzle plate, the channel member, the positioning member, and the fixing member are made of an identical material.

The nozzle plate, the channel member, the positioning member, and the fixing member are made of the same type of stainless steel material.

The channel member has the communication hole extending in the second direction, and the communication hole communicates the outer peripheral surface of the channel member with the second positioning hole.

The communication hole has a female screw portion, and the fixing member has a male screw portion to be engaged with the female screw portion of the communication hole.

The nozzle plate has a nozzle array having multiple nozzles having the nozzle arrayed in the second direction, and the positioning member positions both ends of the nozzle plate, outside the nozzle array in the second direction, relative to the channel member.

The nozzle plate has at least two first positioning holes including the first positioning hole, one of the at least two first positioning holes has a round hole on one end of the nozzle plate in the second direction, and another of the at least two first positioning holes has a long hole, elongated in the second direction, on another end of the nozzle plate in the second direction.

The nozzle plate has a nozzle array having multiple nozzles having the nozzle arrayed in the second direction, the positioning member positions: both ends of the nozzle plate, outside the nozzle array in the second direction; and a central portion between the both ends in the second direction, relative to the channel member. The nozzle plate has multiple positioning holes having the first positioning hole, and the multiple positioning holes have: a long hole on each of the both ends of the nozzle plate in the second direction, the long hole elongated in the second direction; and a round hole on the central portion of the nozzle plate in the second direction.

The fixing member presses the positioning member, inserted into the round hole, against the inner peripheral surface of at least one of the first positioning hole or the second positioning hole.

The liquid discharge head further includes: a second fixing member pressing, in a third direction orthogonal to the first direction and the second direction, the outer peripheral surface of the positioning member into contact with the inner peripheral surface of at least one of the first positioning hole or the second positioning hole. The channel member has another communication hole on another outer peripheral surface of the channel member, said another communication hole extends in the third direction, and the second fixing member is inserted through said another communication hole in the third direction.

The liquid discharge head further includes a valve member to open and close the nozzle; and an actuator to move the valve member between: a closing position to close the nozzle; and an opening position to open the nozzle.

A liquid discharge apparatus includes the liquid discharge head and a scanner to move the liquid discharge head.

According to the present embodiment, the nozzle plate and the channel member can be accurately positioned.

The above-described embodiments are limited examples, and the present disclosure includes, for example, the following aspects having advantageous effects.

### Aspect 1

According to Aspect 1, a liquid discharge head 1 includes: a nozzle plate 101 having a nozzle 111, a channel member such as a lower housing 10b having a channel 112 through which liquid to be discharged from the nozzle 111 flows; and a positioning member such as a positioning pin 140 that is inserted into a main reference positioning hole 130a of the nozzle plate 101 and a positioning hole 131a of the channel member and positions the nozzle plate 101 on the channel member, the positioning member having a predetermined gap between the positioning member and each of the main reference positioning hole 130a of the nozzle plate 101 and the positioning hole 131a of the channel member, the liquid discharge head including a fixing member 160a that presses the positioning member from a direction orthogonal to an insertion direction of the positioning member being inserted into the positioning hole to bring an outer peripheral surface of the positioning member into contact with an inner peripheral surface of at least one of the two positioning holes, and secure the positioning member in the positioning hole in a posture parallel to the insertion direction.

Since the positioning member is inserted into both the positioning hole of the nozzle plate and the positioning hole of the channel member with a predetermined gap, thermal expansion of the positioning member due to heating during diffusion bonding can be released. Thus, it is possible to prevent deterioration in positioning accuracy of the nozzle plate with respect to the channel member due to deformation of the positioning member or deformation of the positioning hole.

However, the configuration in which the positioning member is inserted into the positioning hole of the channel member with a gap causes the following problems.

That is, even if the nozzle plate and the channel member are made of the same material, since the heat capacities are different from each other, temperature rise speeds are different, and the thermal expansion of the nozzle plate and the thermal expansion of the channel member are different from each other at the time of temperature rise to 800 to 1000° C. in the diffusion bonding. In the configuration in which the positioning member is inserted into both the positioning hole of the nozzle plate and the positioning hole of the channel member with a predetermined gap, the positioning member is pushed by the inner peripheral surface of the positioning hole of the member having the higher temperature rise speed among the nozzle plate and the channel member, and the positioning member is inclined in the positioning hole. As a result, a positional shift of the nozzle plate with respect to the channel member deviates more than the gap between the positioning member and the positioning hole, and the positioning accuracy deteriorates. This problem is not limited to the diffusion bonding, and can similarly occur when the nozzle plate and the channel member are bonded using heat such as thermal bonding.

On the other hand, in the first aspect, the positioning member is pressed by the fixing member from the direction orthogonal to the insertion direction, and the outer peripheral surface is abutted against the inner peripheral surface of the positioning hole and is clamped and secured in a posture parallel to the insertion direction and heated. As described above, since the positioning member is clamped and secured in the posture parallel to the insertion direction, it is possible to prevent the inclination of the positioning member due to pressing of a member having a high temperature rise speed at the time of temperature rise of the diffusion bonding as compared with the positioning member not clamped and secured. Therefore, it is possible to prevent a decrease in positioning accuracy due to the inclination of the positioning member.

### Aspect 2

According to Aspect 2, in the liquid discharge head of Aspect 1, the nozzle plate 101 is joined to the channel member such as the lower housing 10b by diffusion bonding.

With this configuration, as described in the embodiment, it is possible to prevent the nozzle plate 101 from being joined to the channel member in an inclined manner in a liquid discharge direction as compared with the case where the nozzle plate 101 is joined to the lower housing 10b using an adhesive.

### Aspect 3

According to Aspect 3, in the liquid discharge head of Aspect 1 or 2, the nozzle plate 101, the channel member such as the lower housing 10b, the positioning member such as the positioning pin 140, and the fixing member 160a are made of an identical material.

With this configuration, as described in Example 1, the nozzle plate 101, the channel member such as the lower housing 10b, the positioning member such as the positioning pin 140, and the fixing member 160a can have the same linear expansion coefficient. Thus, it is possible to prevent generation of stress due to a thermal expansion difference at the time of joining using heat such as diffusion bonding, and it is possible to prevent deformation of the member.

### Aspect 4

According to Aspect 4, in the liquid discharge head of Aspect 3, the channel member such as the nozzle plate 101 and the lower housing 10b, the positioning member such as the positioning pin 140, and the fixing member 160a are made of the same type of stainless steel material.

With this configuration, as described in Example 1, corrosion can be prevented, and the life can be extended.

### Aspect 5

According to Aspect 5, in the liquid discharge head of any one of Aspects 1 to 4, the channel member such as the lower housing 10b has a communication hole such as the female screw portion 150a that extends in a direction orthogonal to the insertion direction of the positioning member, such as the positioning pin 140, being inserted into the positioning hole 131a to communicate an outer peripheral surface of the channel member with the positioning hole 131a of the channel member, and into which the fixing member 160a is inserted.

With this configuration, as described in Example 1, the positioning member such as the positioning pin 140 inserted into the positioning hole 131a of the channel member such as the lower housing 10b can be pushed in from the direction orthogonal to the insertion direction of the positioning member being inserted into the positioning hole by the fixing member inserted into the communication hole. Therefore, the outer peripheral surface of the positioning member is brought into contact with the inner peripheral surface of the positioning hole 131a of the channel member, and the positioning member can be secured in the positioning hole 131a of the channel member in a posture parallel to the insertion direction (Z direction).

### Aspect 6

According to Aspect 6, in the liquid discharge head of Aspect 5, the communication hole includes a female screw portion, and the fixing member 160a includes a male screw portion screwed to the female screw portion.

With this configuration, as described in Example 1, by screwing the fixing member 160a into the communication hole such as the female screw portion 150a, the positioning member such as the positioning pin 140 can be pushed in from the direction orthogonal to the insertion direction of the positioning member being inserted into the positioning hole. Thus, the positioning member can be clamped and secured in a posture parallel to the insertion direction (Z direction) by the fixing member 160a and the outer peripheral surface of the positioning hole of the channel member such as the lower housing 10b.

### Aspect 7

According to Aspect 7, in the liquid discharge head of any one of Aspects 1 to 6, the nozzle plate 101 has a nozzle row in which a plurality of nozzles 111 is arranged, and both ends of the nozzle plate 101 in a nozzle arrangement direction (X direction) are positioned on a channel member such as a lower housing.

With this configuration, as described in Example 1, the nozzle plate 101 can be positioned with respect to the channel member such as the lower housing 10b about the nozzle arrangement direction (X direction), the liquid discharge direction (Z direction), a direction (Y direction) orthogonal to both of the nozzle arrangement direction and the liquid discharge direction (Z direction).

### Aspect 8

According to Aspect 8, in the liquid discharge head of Aspect 7, a positioning hole arranged on one end side in the nozzle arrangement direction of the nozzle plate 101 is a round hole, and a positioning hole arranged on another end side in the nozzle arrangement direction of the nozzle plate 101 is a long hole elongated in the nozzle arrangement direction.

With this configuration, as described in Example 2, the nozzle plate 101 can be accurately positioned in the nozzle arrangement direction (X direction) and the direction (Y direction) orthogonal to both the liquid discharge direction (Z direction) and the nozzle arrangement direction by the positioning hole arranged on one end side in the nozzle arrangement direction. The nozzle plate 101 can be accurately positioned about the Z direction by the positioning hole arranged on the other end side in the nozzle arrangement direction.

By making the positioning hole on the other end side as a long hole long in the nozzle arrangement direction (X direction), it is possible to prevent the positioning hole on the other end side of the nozzle plate from abutting on a positioning member such as a positioning pin due to thermal expansion of the nozzle plate at the time of temperature rise in the diffusion bonding. Thus, it is possible to prevent restriction of thermal expansion in the nozzle arrangement direction by the positioning member on the other end side, and it is possible to prevent occurrence of deformation such as warping or waving of the nozzle plate.

### Aspect 9

According to Aspect 9, in the liquid discharge head of any one of Aspects 1 to 6, the nozzle plate 101 has a nozzle row in which a plurality of nozzles 111 is arranged, the nozzle plate 101 is positioned in the channel member such as the lower housing 10b at three locations of both ends in a nozzle arrangement direction (X direction) of the nozzle plate 101 and a central portion positioned between the both ends in the nozzle arrangement direction, the main reference positioning hole 130a and the sub-reference positioning hole 130b arranged at the both ends in the nozzle arrangement direction of the nozzle plate 101 are long holes elongated in the nozzle arrangement direction (X direction), and a main reference positioning hole 130c arranged at the central portion in the nozzle arrangement direction is a round hole.

With this configuration, as described in Example 3, the nozzle plate 101 can be accurately positioned in the nozzle arrangement direction (X direction) and the direction (Y direction) orthogonal to both the liquid discharge direction (Z direction) and the nozzle arrangement direction (X direction) by the main reference positioning hole 130c arranged at the center in the nozzle arrangement direction of the nozzle plate. The nozzle plate 101 can be accurately positioned about the Z direction by the long holes of the main reference positioning hole 130a and the sub-reference positioning hole 130b arranged at the both ends in the nozzle arrangement direction (X direction) of the nozzle plate.

By making the positioning holes at the both ends as long holes elongated in the nozzle arrangement direction (X direction), it is possible to prevent the main reference positioning hole 130a and the sub-reference positioning hole 130b at the both ends of the nozzle plate from abutting on a positioning member such as the positioning pin 140 due to thermal expansion of the nozzle plate at the time of temperature rise in the diffusion bonding. Thus, it is possible to prevent restriction of thermal expansion in the nozzle arrangement direction by the positioning member at the both ends, and it is possible to prevent occurrence of deformation such as warping or waving of the nozzle plate.

### Aspect 10

According to Aspect 10, in the liquid discharge head of Aspect 8 or 9, a positioning member such as the positioning pin inserted into the positioning hole being the round hole is secured by the fixing member 160a.

With this configuration, the positioning hole being the round hole of a main reference for positioning is more likely to come into contact with the positioning member due to thermal expansion of the nozzle at the time of temperature rise of the diffusion bonding than the positioning hole being the long hole of a sub-reference for positioning. Therefore, by fixing the positioning member such as the positioning pin 140 inserted into the positioning hole being the round hole with the fixing member, it is possible to prevent the positioning member from being inclined due to thermal expansion of the nozzle plate 101 at the time of temperature rise of the diffusion bonding.

On the other hand, the positioning hole to be inserted into the positioning hole of the sub-reference long hole for positioning is not secured by the fixing member and can freely move. Thus, when the sub-reference positioning hole abuts on the positioning member such as the positioning pin 140 due to the thermal expansion of the nozzle plate at the time of temperature rise of the diffusion bonding, the positioning pin moves to allow the thermal expansion of the nozzle plate. Thus, unlike Comparative Example 2 in which the positioning member inserted into the sub-reference positioning hole is also secured with the fixing member, deformation is prevented so that the nozzle plate is warped or wavy.

### Aspect 11

According to Aspect 11, in the liquid discharge head of any one of Aspects 1 to 10, there is provided a second fixing member such as a second fixing member 160b that secures the positioning pin in the positioning hole in a state where the positioning member is pushed in from a direction different from a direction in which the positioning member such as the positioning pin 140 of the fixing member 160a is pushed in, and an outer peripheral surface of the positioning member is brought into contact with an inner peripheral surface of the positioning hole.

With this configuration, as described in Example 3, the positioning member such as the positioning pin 140 can be firmly secured in the posture parallel to the insertion direction (Z direction), and it is possible to further prevent the positioning member from being inclined when the positioning member is pushed due to thermal expansion of the nozzle plate at the time of temperature rise of the diffusion bonding.

### Aspect 12

According to Aspect 12, in the liquid discharge head of any one of Aspects 1 to 11, a valve member such as a needle valve 113 that opens and closes the nozzle 111 and a moving unit such as a piezoelectric element 114 that moves the valve member between a closing position to close the nozzle 111 and an open position to open the nozzle 111 are provided.

With this configuration, as described in Example 1, it is possible to favorably prevent a concentricity shift which is a positional shift between the center of the nozzle 111 and the axial center of the valve member such as the needle valve 113, and it is possible to favorably prevent discharge bending and sealing failure.

### Aspect 13

According to Aspect 13, a liquid discharge apparatus uses the liquid discharge head of any one of Aspects 1 to 12 as a liquid discharge head.

With this configuration, the liquid can be discharged favorably.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having:
a nozzle from which a liquid is dischargeable in a first direction; and
a first positioning hole extending in the first direction;
a channel member on the nozzle plate having:
a channel communicating with the nozzle;
a second positioning hole extending in the first direction; and
a communication hole on an outer peripheral surface of the channel member, the communication hole extending in a second direction orthogonal to the first direction;
a positioning member inserted into the first positioning hole and the second positioning hole in the first direction to position the nozzle plate relative to the channel member; and
a fixing member inserted through the communication hole in the second direction, the fixing member pressing, in the second direction, an outer peripheral surface of the positioning member into contact with an inner peripheral surface of at least one of the first positioning hole or the second positioning hole,
wherein the positioning member has a predetermined gap between the positioning member and each of the first positioning hole and the second positioning hole.

2. The liquid discharge head according to claim 1,
wherein the nozzle plate is joined to the channel member by diffusion bonding.

3. The liquid discharge head according to claim 1,
wherein the nozzle plate, the channel member, the positioning member, and the fixing member are made of an identical material.

4. The liquid discharge head according to claim 3,
wherein the nozzle plate, the channel member, the positioning member, and the fixing member are made of a same type of stainless steel material.

5. The liquid discharge head according to claim 1,
wherein the channel member has the communication hole extending in the second direction, and
the communication hole communicates the outer peripheral surface of the channel member with the second positioning hole.

6. The liquid discharge head according to claim 5,
wherein the communication hole has a female screw portion, and
the fixing member has a male screw portion to be engaged with the female screw portion of the communication hole.

7. The liquid discharge head according to claim 1,
wherein the nozzle plate has a nozzle array having multiple nozzles having the nozzle arrayed in the second direction, and
the positioning member positions both ends of the nozzle plate, outside the nozzle array in the second direction, relative to the channel member.

8. The liquid discharge head according to claim 7,
wherein the nozzle plate has at least two first positioning holes including the first positioning hole,
one of the at least two first positioning holes has a round hole on one end of the nozzle plate in the second direction, and
another of the at least two first positioning holes has a long hole, elongated in the second direction, on another end of the nozzle plate in the second direction.

9. The liquid discharge head according to claim 1,
wherein the nozzle plate has a nozzle array having multiple nozzles having the nozzle arrayed in the second direction,
the positioning member positions:
both ends of the nozzle plate, outside the nozzle array in the second direction; and
a central portion between the both ends in the second direction,
relative to the channel member,
the nozzle plate has multiple positioning holes having the first positioning hole, and
the multiple positioning holes have:
a long hole on each of the both ends of the nozzle plate in the second direction, the long hole elongated in the second direction; and
a round hole on the central portion of the nozzle plate in the second direction.

10. The liquid discharge head according to claim 8,
wherein the fixing member presses the positioning member, inserted into the round hole, against the inner peripheral surface of at least one of the first positioning hole or the second positioning hole.

11. The liquid discharge head according to claim 1, further comprising:
a second fixing member pressing, in a third direction orthogonal to the first direction and the second direction, the outer peripheral surface of the positioning member into contact with the inner peripheral surface of at least one of the first positioning hole or the second positioning hole,
wherein the channel member has another communication hole on another outer peripheral surface of the channel member,
said another communication hole extends in the third direction, and
the second fixing member is inserted through said another communication hole in the third direction.

12. The liquid discharge head according to claim 1, further comprising:
a valve member to open and close the nozzle; and
an actuator to move the valve member between:
a closing position to close the nozzle; and
an opening position to open the nozzle.

13. A liquid discharge apparatus comprising
the liquid discharge head according to claim 1; and
a scanner to move the liquid discharge head.
